(19) United States
(12) Patent Application Publication
(10) Pub. No.: US 2026/0323698 A1
(43) Pub. Date: Oct. 15, 2026

(54) GNSS MEASUREMENT GAP TRIGGER WITH AND WITHOUT HARQ FEEDBACK

(71) Applicant: Telefonaktiebolaget LM Ericsson (publ), Stockholm (SE)

(72) Inventors: Gerardo Agni MEDINA ACOSTA, Stockholm (SE); Talha KHAN, Santa Clara, CA (US)

(21) Appl. No.: 19/483,654

(22) PCT Filed: May 10, 2024
(86) PCT No.: PCT/EP2024/062994

§ 371 Date: Nov. 12, 2025

Related U.S. Application Data
(60) Provisional application No. 63/466,149, filed on May 12, 2023.
(60) Provisional application No. 63/466,196, filed on May 12, 2023.

(51) Int. Cl. H04W 74/0816; H04L 1/1812; H04L 27/26; H04W 84/06

(52) U.S. Cl. CPC H04W 74/0816; H04L 1/1812; H04L 27/26025; H04W 84/06

(57) ABSTRACT

Methods and systems are described for configuring GNSS measurement gaps by a network node or a UE. For example, an embodiment can comprise a method performed by a UE (3200) for being configured with a GNSS measurement gap. The method can comprise receiving (2510), from a network node (3300), one or more values capable of defining a GNSS measurement gap instance, wherein the one or more values define the GNSS measurement gap instance regardless of whether a HARQ feedback is enabled or disabled for one or more downlink HARQ processes.

### TECHNICAL FIELD

The present disclosure generally relates to systems and methods for configuring GNSS measurement gaps, and in particular, consideration of whether a Hybrid Automatic Repeat request, HARQ, feedback is enabled or disabled for one or more downlink HARQ processes.

### BACKGROUND

Future developments in 5G and related technologies will include uses for both the internet of things (IoT) and non-terrestrial networks (NTN).

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a UE.
   Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A satellite which does not operate in geostationary earth orbit is also broadly called as NGSO (Non-Geostationary Orbit) satellite. Examples of NGSO satellites are LEO and MEO satellites.

Two basic architectures can be distinguished for satellite communication networks, depending on the functionality of the satellites in the system: transparent payload and regenerative payload.

In transparent payload (also referred to as bent pipe architecture) the satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE.

In regenerative payload the satellite includes on-board processing to demodulate and decode the received signal and regenerate the signal before sending it back to the earth. When applied to general 3GPP architecture and terminology, the regenerative payload architecture means that the gNB is located in the satellite.

In a work item for NR NTN in 3GPP release 17, only the transparent payload architecture is considered. A satellite network or satellite based mobile network may also be called as non-terrestrial network (NTN). A satellite within NTN may be called NTN node, NTN satellite or simply a satellite. FIG. 1 shows an example architecture of a satellite network with bent pipe transponders (i.e., the transparent payload architecture). The gNB may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits is required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A 3GPP device in RRC_IDLE or RRC_INACTIVE state is required to perform number of procedures including measurements for mobility purposes, paging monitoring, logging measurement results, tracking area update, and search for a new PLMN to mention a few. These procedures will consume power in devices, and a general trend in 3GPP has been to allow for relaxation of these procedures to prolong device battery life. This trend has been especially pronounced for IoT devices supported by reduced capability (redcap), NB IoT and LTE M.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE (user equipment) and a satellite can vary significantly, depending on the position of the satellite and thus the elevation angle & seen by the UE. Assuming circular orbits, the minimum distance is realized when the satellite is directly above the UE (ε=90°), and the maximum distance when the satellite is at the smallest possible elevation angle. FIG. 2 shows the propagation delay distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

The propagation delay may also be highly variable due to the high velocity of the LEO and MEO satellites and change in the order of 10-100 μs every second, depending on the orbit altitude and satellite velocity.

In 3GPP TR 38.821 V16.2.0, it has been captured that ephemeris data should be provided to the UE, for example to assist with pointing a directional antenna (or an antenna beam) towards the satellite. A UE knowing its own position, e.g. thanks to GNSS (Global Navigation Satellite System) support, may also use the ephemeris data to calculate correct timing related and/or frequency drifts e.g. Timing Advance (TA) and Doppler shift. The contents of the ephemeris data and the procedures on how to provide and update such data have not yet been studied in detail.

A satellite orbit can be fully described using six parameters. Exactly which set of parameters is used can be decided by the user; many different representations are possible. For example, a choice of parameters used often in astronomy is the set (α, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g. the time when the satellites moves through periapsis). The set of these parameters is illustrated in FIG. 3.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vx, vy, vz) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

To handle the timing and frequency synchronization in an NR or LTE based NTN, the device is equipped with a Global Navigation Satellite System (GNSS) receiver. The GNSS receiver allows a device to estimate its geographical position. The UE can then determine the propagation delay, the delay variation, the Doppler shift and its variation rate based on its own and the satellite's location information.

In a Release 17 study item on NB-IoT and LTE-M for NTN and Rel-17 and Rel-18 work items on IoT NTN, simultaneous operation of NB-IoT/eMTC and GNSS is not assumed.

The background to this 3GPP assumption is that a cellular device may share parts of its RF architecture between the cellular modem and the GNSS chip. A basic solution is to make use of the same antenna for receiving the GNSS reference signal, and for receiving and transmitting an LTE or NR signal. A switch determines if the antenna should be connected to the cellular RF frontend or the GNSS RF frontend. The switch provides the needed isolation between the cellular transmitter and the GNSS receiver, but does also prevent simultaneous GNSS and cellular operation.

In 3GPP TR 36.763 V17.0.0, the impact of GNSS position fix on the battery life of an IoT NTN UE has been documented. In addition several aspects related to GNSS operation e.g. GNSS measurement gaps were also studied and documented in 3GPP TR 36.763 V17.0.0.

Below are listed the relevant agreements on GNSS enhancements made in 3GPP RAN1 meetings during the Rel-17 IoT NTN WI. In this WI, a GNSS validity duration parameter was introduced. Upon GNSS acquisition, a UE will autonomously determine its GNSS validity duration from the agreed set of values and report it to the network. Upon expiry of GNSS validity duration during RRC_CONNECTED state, a UE is expected to return to idle mode to refresh its GNSS position, i.e., GNSS acquisition during connected mode is not supported.
Agreement:
For sporadic short transmission, UE in RRC_CONNECTED should go back to idle mode and re-acquire a GNSS position fix if GNSS becomes outdated.
Agreement
The UE autonomously determines its GNSS validity duration X and reports information associated with this valid duration to the network via RRC signalling.
   X={10 s, 20 s, 30 s, 40 s, 50 s, 60 s, 5 min, 10 min, 15 min, 20 min, 25 min, 30 min, 60 min, 90 min, 120 min, infinity}

In the Rel-18 IoT NTN WI, the focus has been on long connections where the GNSS expires during the connected mode. Instead of following the default Rel-17 procedure where a UE in RRC_CONNECTED mode returns to RRC_IDLE mode upon GNSS expiry, an enhanced UE behavior is under discussion where the UE is allowed to reacquire its GNSS position fix during the RRC_CONNECTED state. Moreover, another goal is to reduce the number of GNSS position fixes that a UE may need during RRC_CONNECTED mode in order to reduce UE power consumption.

Several agreements were made regarding closed loop time and frequency correction:
Agreement
Closed loop time and frequency correction, with potential enhancements, for IoT-NTN is considered to reduce the need for UE to update GNSS position fix in long connection time.
Agreement
At least for the case when frequency error is within frequency error requirements, study the mechanisms and conditions to allow UL transmission after original GNSS validity duration expires without GNSS re-acquisition for some duration.
   FFS: with legacy closed loop time correction or enhanced closed loop time correction
   This mechanism is enabled/configured by eNB.
FFS: whether such mechanism will be specified depends on the outcome of this study

Several agreements were made regarding GNSS position fix in RRC_Connected state:
Agreement
At least the following options can be considered on GNSS measurement in connected for potential enhancements for improved GNSS operations:
   Option 1: UE re-acquires GNSS position fix during RLF procedure
   Option 2: UE re-acquires GNSS position fix with a new gap
Note: this does not imply that a Rel-18 IoT NTN UE is mandated to support one or both of the options.
Agreement
Further study on whether there is a need for potential enhancements on the following for long connection time
   UE triggered GNSS measurement.
   Network triggered GNSS measurement.
Agreement
Support eNB to at least aperiodically trigger UE to make GNSS measurement.
Agreement
If eNB aperiodically triggers UE to make GNSS measurement, a MAC CE is used.
Agreement
For GNSS measurement in RRC connected, if eNB aperiodically triggers connected UE to make GNSS measurement, UE can re-acquire GNSS position fix with a gap
   FFS details of gap configuration
Agreement
The UE may re-acquire GNSS autonomously (when configured by the network) if UE does not receive eNB trigger to make GNSS measurement
   FFS based on configured timing
Agreement
On when the GNSS measurement gap starts, which is aperiodically triggered by eNB with MAC CE, RAN1 can down select one of the following alternatives:
Alt 1: the start time should be at n+X, where n is the end of MAC CE receiving subframe/slot
   FFS: details of X, e.g. predefined value or configured value
Alt 2: the start time should be based on the current GNSS validity duration with delay or without delay
Agreement
On the length of GNSS measurement gap, which is aperiodically triggered by eNB, the gap duration should be equal to or larger than the latest UE reported GNSS position fix time duration.
FFS: whether the gap duration is configured by eNB, or the gap duration is equal to the latest reported GNSS position fix time duration.
Agreement
For the GNSS measurement gap aperiodically triggered with MAC CE, the duration for the GNSS measurement gap can be configured by eNB.
The gap duration is equal to the latest reported GNSS position fix time duration for measurement when the duration for GNSS measurement gap is not included in the configuration by eNB.
Agreement
UE reports one GNSS position fix time duration for GNSS measurement via a N-bit field at least including [1,2] seconds as component values.
1. FFS: value of N, other component value(s) of candidate GNSS position fix time duration (e.g. N=3, with value in [1, 2, 3, 7, 13, 19, 25, X] seconds, and X is FFS).
FFS: whether RAN4 input is needed.
Agreement
On when the aperiodic GNSS measurement gap starts, which is aperiodically triggered by eNB with MAC CE, the start time should be at n+X, where n is the end of MAC CE receiving subframe/slot
   FFS: details of X, e.g. predefined value or configured value, considering HARQ feedback for the MAC CE, etc

Several agreements were made regarding GNSS assistance information:
Agreement
GNSS assistance information that UE reports to eNB at least consists of:
   GNSS position fix time duration for measurement
   GNSS validity duration
Agreement
When eNB triggers UE to make GNSS measurements, UE re-acquires GNSS position fix.
   FFS details of signalling
   FFS how UE reports GNSS assistance information after eNB trigger and the detailed content.
   Note: further discuss whether a UE is expected to handle all eNB triggers
Agreement
UE reports GNSS position fix time duration for measurement at least during the initial access stage.
   which message carries this information is up to RAN2
Agreement
In connected mode, UE may report GNSS validation duration with MAC CE.
Agreement
UE reports only one GNSS position fix time duration for GNSS measurement at least when moving to RRC connected state.
Agreement
The following alternatives can be considered to inform eNB the success of GNSS measurement at UE side after GNSS measurement in RRC connected.
   Alt-1: The UE will report the new GNSS validity duration.
   Alt-2: The reception of any UL transmission from the UE at eNB after the GNSS measurement.

IoT-NTN relies on the legacy framework that LTE-MTC (Long Term Evolution-Machine Type Communication) and NB-IoT use to transmit HARQ (Hybrid Automatic Repeat reQuest) feedback. The NB-IoT (Narrowband-Internet of Things) framework allows to use up to two HARQ processes for a Cat-NB2 UE. FIG. 4 shows a table of use of 2 HARQ processes for a Cat-NB2 UE.

In FIG. 4, NPDCCH #0 and NPDSCH #0 refer to the control channel and corresponding user data associated to HARQ Process #0. NPUSCH Format 2 #0 carries the ACK/NACK (acknowledgement-non-acknowledgement) for HARQ Process #0. The other HARQ process depicted in FIG. 4 follows the same logic and terminology respectively.

The procedure to report ACK/NACK is described in 3GPP TS 36.213 V17.5.0 as follows:

### 16.4.2 UE Procedure for Reporting ACK/NACK

The UE shall upon detection of a NPDSCH transmission ending in NB-IoT subframe n intended for the UE and for which an ACK/NACK shall be provided, start, after the end of
   n+k′₀+K_{offset}−1 DL subframe for FDD,
   k′₀−1 NB-IoT UL subframes following the end of n+12 subframe for TDD,
transmission of the NPUSCH carrying ACK/NACK response, and SR (if any) if the serving cell is FDD and the UE is configured with higher layer parameter sr-with-HARQ-ACK-Config, using NPUSCH format 2 in N consecutive NB-IoT UL slots, where
   N=N′_{TB}N_{Rep}^{AN}Nₛₗₒₜₛ^{UL}, where
      the value of N_{Rep}^{AN} is given by the higher layer parameter ack-NACK-NumRepetitions-Msg4 configured for the associated NPRACH resource for Msg4 NPDSCH transmission, and higher layer parameter ack-NACK-NumRepetitions otherwise,
      the value of Nₛₗₒₜₛ^{UL} slots is the number of slots of the resource unit (defined in clause 10.1.2.3 of [TS 36.213 Ver. 17.5.0]), and
      if the UE is configured with higher layer parameter harq-ACK-Bundling in npdsch-MultiTB-Config, then N′_{TB}=1, otherwise N′_{TB}=N_{TB}, where the value of N_{TB} is determined by the Number of scheduled TB for Unicast field if present in the NPDCCH corresponding to the NPDSCH, otherwise N_{TB}=1,
   allocated subcarrier for ACK/NACK and value of k₀ is determined by the ACK/NACK resource field in the DCI format of the corresponding NPDCCH according to Table 16.4.2-1, and Table 16.4.2-2,
      for FDD, k′₀=k₀.
      for TDD, k′₀=k₀−12.
   For N_{TB}>1
      if the UE is configured with higher layer parameter harq-AckBundling in npdsch-MultiTB-Config, and the NPDSCH corresponding to a NPDCCH with DCI CRC scrambled by C-RNTI,
         the ACK/NACK response is generated by performing a logical AND operation of HARQ-ACKs corresponding to the TBᵣ₊₁, r=0, 1, . . . N_{TB}−1
      otherwise,
         NB-IoT UL slots

$${n}_{r \cdot {N}_{Rep}^{AN} {N}_{slots}^{UL} + l}$$

with l=0, 1, . . . N_{Re}^{AN}Nₛₗₒₜₛ^{UL}−1 of the NPUSCH carry ACK/NACK response for TBᵣ₊₁, r=0, 1, . . . N_{TB}−1

FIG. 5 shows, from 3GPP TS 36.213 V17.5.0, Table 16.4.2-1: ACK/NACK subcarrier and for NPUSCH with subcarrier spacing. FIG. 6 shows, from TS 3GPP TS 36.213 V17.5.0, Table 16.4.2-2: ACK/NACK subcarrier and for NPUSCH with subcarrier spacing.

The LTE-MTC framework allows to use up to 8 HARQ processes, 10 HARQ processes, or up to 14 HARQ processes. FIG. 7 illustrates the framework of “ce-PDSCH-14HARQ-Config-r17”, which in Rel-17 introduced the possibility of using up to 14 HARQ processes in downlink for HD-FDD Cat M1 UEs. FIG. 7 shows a table of combined usage of up to 14 HARQ processes and HARQ-ACK bundling for a Cat-M1 HD-FDD UE. In FIG. 7, MPDCCH #0 and PDSCH #0 refer to the control channel and the corresponding user data associated to HARQ Process #0. PUCCH #0 in Subframe #13 bundles four ACKs/NACKs associated to multiple HARQ processes (see numbers surrounded by brackets). Other HARQ processes depicted in FIG. 7 follow the same logic and terminology respectively.

An extract of the FDD HARQ-ACK reporting procedure from 3GPP TS 36.213 V17.5.0 is referred below:
For a BL/CE UE with higher layer parameter ce-PDSCH-14HARQ-Config not configured, for PDSCH transmission in subframe n-k-K_{offset}, if the UE is in half-duplex FDD operation and is configured with CEModeA and higher layer parameter ce-HARQ-AckBundling and the ‘HARQ-ACK bundling flag’ in the corresponding DCI is set to 1, or if the UE is configured with higher layer parameter ce-SchedulingEnhancement,
   if the ‘HARQ-ACK delay’ field in the corresponding DCI indicates value k, the UE shall determine the subframe n as the HARQ-ACK transmission subframe.
   the HARQ-ACK delay value k is determined from the corresponding DCI based on the higher layer parameters according to Table 7.3.1-2.
For a BL/CE UE with higher layer parameter ce-PDSCH-14HARQ-Config configured, for PDSCH transmission in subframe n-k-K_offset, if the UE is in half-duplex FDD operation and is configured with CEModeA, and ‘PDSCH scheduling delay and HARQ-ACK delay for 14 HARQ’ field is present in the corresponding DCI,
   if the HARQ-ACK delay value as defined in [3GPP TS 36.212, Ver. 17.1.0], in the corresponding DCI indicates value k, the UE shall determine the subframe n as the HARQ-ACK transmission subframe.
For a BL/CE UE in half-duplex FDD operation, if the UE is configured with CEModeA, and if the UE is configured with higher layer parameter ce-HARQ-AckBundling and the ‘HARQ-ACK bundling flag’ in the corresponding DCI is set to 1,
   for HARQ-ACK transmission in subframe n, the UE shall generate one HARQ-ACK bit by performing a logical AND operation of HARQ-ACKs across all 1≤M≤4 BL/CE DL subframes for which subframe n is the ‘HARQ-ACK transmission subframe’.
   if subframe n−k₁ is the most recent subframe for which subframe n is the ‘HARQ-ACK transmission subframe’, and if the ‘Transport blocks in a bundle’ field in the corresponding DCI for PDSCH transmission in subframe n−k₁ indicates a number of transport blocks in a bundle other than M, the UE shall generate a NACK for HARQ-ACK transmission in subframe n.
   if the UE has received W PDSCH transmissions before subframe n, and if the UE is expected to transmit HARQ-ACK for the W PDSCH transmissions in subframes {n₁ . . . n_{L}},nᵢ≥n the UE is not expected to receive a new PDSCH transmission in subframe n, where W=10 if higher layer parameter ce-pdsch-tenProcesses-config is set to ‘On’, W=12 if higher layer parameter ce-PDSCH-14HARQ-Config is configured, and W=8 otherwise.
   if the UE is expected to transmit HARQ-ACK for the PDSCH transmissions received before subframe n in subframes {n₁, n₂, n₃}, nᵢ≥n, the UE is not expected to receive a new PDSCH transmission in subframe n for which the HARQ-ACK is to be transmitted in subframe n₄ ∉{n₁, n₂, n₃}.

Related to the extract above, FIG. 8 shows Table 7.3.1-2: HARQ-ACK delay for BL/CE UE in CEModeA from 3GPP TS 36.213 V17.5.0.

The HARQ-ACK delays for the case when 14-HARQ processes are configured were captured in 3GPP TS 36.212 V17.5.0 as shown in FIGS. 9 to 11. FIG. 9 shows Table 5.3.3.1.12-1: Content of “PDSCH scheduling delay and HARQ-ACK delay for 14 HARQ” for ce-HARQ-AckDelay=Alt-2e from 3GPP TS 36.212 V17.5.0. FIG. 10 shows Table 5.3.3.1.12-2: Content of “PDSCH scheduling delay and HARQ-ACK delay for 14 HARQ” for ce-HARQ-AckDelay=Alt-1 from 3GPP TS 36.212 V17.5.0. FIG. 11 shows Table 5.3.3.1.12-3: PDSCH scheduling delay options from 3GPP TS 36.212 V17.5.0.

The Rel-18 “WID on IoT NTN enhancements” includes the following objectives touching upon RAN1:
4.1.1 IoT-NTN Performance Enhancements in Rel-18 to address remaining issues from Rel-17 This work considers Rel-17 IoT-NTN as baseline as well as Rel-17 NR-NTN outcome and the further IoT-NTN performance enhancements objectives are listed below:
   Disabling of HARQ feedback to mitigate impact of HARQ stalling on UE data rates [RAN1, RAN2]
   Study and specify, if needed, improved GNSS operations for a new position fix for UE pre-compensation during long connection times and for reduced power consumption. Simultaneous GNSS and NTN NB-IoT/eMTC operation is not assumed. [RAN1]
      NOTE: The need for RAN4 Core requirements for this objective will be identified after the conclusion on the need for improvements.
The progress reached on this Rel-18 WI until RAN1 #112-bis-e can be briefly summarized as follows:
HARQ feedback can be disabled for both LTE-MTC and NB-IoT.
a. Including scheduling restrictions (a.k.a. no-monitoring rules) determining how early a subsequent DL scheduling can be performed.
A hybrid or mixed scenario is supported, where HARQ processes with enabled and disabled HARQ feedback can co-exist.
a. The scheduling restrictions are combined with legacy procedures as to handle those hybrid scenarios.
A HARQ feedback-switching mechanism using semi-static signaling and/or dynamic signaling has been introduced
a. RRC-based switching
b. RRC-based switching that for a given transmission can be overridden by a DCI-based switching
c. DCI-based switching
Compatibility with other features, e.g., SPS, HARQ-ACK bundling, Multi-TB grant.

It should be noted that some design details associated with the above are still under discussion for both LTE-MTC and NB-IoT.

The full-set of agreements until RAN1 #112-bis-e are listed below:
RAN1 #109
Agreement
For IoT NTN, to configure/indicate enabling/disabling on HARQ feedback for downlink transmission, one or more of the following options can be considered:
   Option 1: per HARQ process via UE specific RRC signaling
   Option 2: per HARQ process via SIB signaling
   Option 3: explicitly indicated by DCI (e.g., new field or reusing existing field)
   Option 4: implicitly determined by existing configured/indicated parameter(s) (e.g., repetition number, TBS)
   Option 5: per HARQ process via MAC CE
   Other options or combinations are not excluded
Note: Option(s) for eMTC and NBIoT can be separately discussed.
Agreement
For IoT NTN, further study the potential issues due to enabling/disabling on HARQ feedback for downlink transmission
   Issue A: SPS PDSCH
   Issue B: (N) PDSCH/(N) PDCCH scheduling restriction
   Issue C: HARQ feedback for scheduling multiple TB
   Issue D: HARQ bundling for eMTC HD-FDD
   Issue F: NPRACH capacity
   Issue G: Serving cell/satellite change during data transfer (FFS: for eMTC and/or NB-IoT)
   Other issues are not excluded
Note: The “Issues” in common for eMTC and NB-IoT can be separately discussed.
RAN1 #110
Agreement
For eMTC NTN, to configure/indicate enabling/disabling of HARQ feedback for downlink transmission, down select one or more from the following options:
   Option 1: per HARQ process via UE specific RRC signaling
   Option 3: explicitly indicated by DCI (e.g., new field or reusing existing field)
   Option 4: implicitly indicated by existing configured/indicated/combined parameter(s) in the
   DCI (e.g., repetition number, TBS)
   Option 6: combinations of some options above.
Agreement
For NB-IoT NTN, to configure/indicate enabling/disabling of HARQ feedback for downlink transmission, down select one or more from the following options:
   Option 1: per HARQ process via UE specific RRC signaling
   Option 3: explicitly indicated by DCI (e.g., new field or reusing existing field)
   Option 4: implicitly indicated by existing configured/indicated/combined parameter(s) in the DCI (e.g., repetition number, TBS).
   Option 6: combinations of some options above
Agreement
For a DL HARQ process with disabled HARQ feedback in NB-IoT, at least the following UE behavior(s) can be considered:
   Option 1: UE is not expected to receive another NPDCCH carrying a DCI scheduling a NPDSCH for a given HARQ process that starts until X (ms) after the end of the reception of the last NPDSCH for that HARQ process.
   X=12
   Option 2: UE is not required to monitor NPDCCH in a period of Y (ms) from the end of reception of the last NPDSCH
   Y=12
Note: it may be different UE behaviors for different UE categories (e.g., UE with single/multiple HARQ processes)
RAN1 #110-bis-e
Agreement
For a DL HARQ process with disabled HARQ feedback in NB-IoT, UE is not required to monitor NPDCCH in a period of Y=12 (ms) from the end of reception of the NPDSCH.
Agreement
For NB-IoT NTN, to configure/indicate enabling/disabling of HARQ feedback for downlink transmission, down select ONE from the following options at RAN1 #111:
   Option 6a-1: Support RRC signaling configured between Option 1 and Option 3
   Option 6a-4: Support Option 1 by default, and support Option 3 to override default configuration for corresponding transmission
RAN1 #111
Working assumption
For NB-IoT NTN and eMTC NTN for CE Mode B, to configure/indicate enabling/disabling of HARQ feedback for downlink transmission:
   Support Option 1 by default, and support Option 3 to override default configuration for corresponding transmission
   Additional RRC signaling to enable Option 3
   If the bitmap for option 1 is not present and if option 3 is configured then the DCI directly indicates HARQ enable/disable. Option 3 can also be configured when the bitmap for option 1 is configured.
   FFS #1: Option 3 DCI-based overridden mechanism is applied to both semi-statically HARQ enabled and disabled processes or only applied to semi-statically HARQ disabled processes or only applied to semi-statically HARQ enabled processes.
   FFS #2: whether/how to support Option 3 overriding default configuration for corresponding transmission for multiple TBs scheduled by single DCI
For eMTC NTN, to configure/indicate enabling/disabling of HARQ feedback for downlink transmission, take Option 1 for CE Mode A.
RAN1 #112
Conclusion
For eMTC HD-FDD single TB scheduled by single DCI, UE is not expected to receive a DCI with “HARQ-ACK bundling flag” field set to 1 in case the corresponding HARQ process is configured with HARQ feedback disabled by RRC signaling.
Agreement
For a DL HARQ process with disabled HARQ feedback in eMTC, UE is not expected to receive another MPDCCH carrying a DCI scheduling a PDSCH for a given HARQ process or to receive another PDSCH without corresponding MPDCCH for the given HARQ process that starts at a BL/CE DL subframe until X=3 (ms) have passed after the end of the reception of the last PDSCH for that HARQ process.
Agreement
For HARQ feedback for eMTC SPS PDSCH, at least the following is supported: UE follows the per-process HARQ feedback enabled/disabled configuration for the associated HARQ process except for the first SPS PDSCH after activation
   for the first SPS PDSCH after activation,
   Option 1: If HARQ feedback for SPS activation is additionally enabled, ACK/NACK is reported by UE for the first SPS PDSCH after activation regardless of network configuration of enabled/disabled for this HARQ process, and follow per-process HARQ feedback enabled/disabled configuration otherwise.
Conclusion
For DCI indicating SPS PDSCH release, HARQ-ACK report is performed as legacy in eMTC, regardless of HARQ feedback enabled/disabled configuration.
Agreement
For DCI-based overridden mechanism/indication in single TB scheduled by DCI, down select one of the following alternatives based on the criteria DCI overhead, PDCCH monitoring/power consumption, HARQ timer, impact on scheduling flexibility, UE implementation complexity
   Alternative 1: applies to both semi-statically HARQ enabled and disabled processes
   Alternative 2: only applied to semi-statically HARQ disabled processes
   Alternative 3: only applied to semi-statically HARQ enabled processes
Agreement
Confirm the following working assumption with the following update:
Working assumption
For NB-IoT NTN and eMTC NTN for CE Mode B, to configure/indicate enabling/disabling of HARQ feedback for downlink transmission:
   Support Option 1 in case only per-HARQ process bitmap signaling is configured
   Support Option 3 DCI direct indication of HARQ feedback enable/disable in case only DCI solution enabling/disabling signaling is configured
   Support Option 3 DCI indication to override Option 1 configuration for corresponding transmission in case both per-HARQ process bitmap and DCI solution enabling/disabling signaling are configured
      FFS #1: Option 3 DCI-based overridden mechanism is applied to both semi-statically HARQ feedback enabled and disabled processes or only applied to semi-statically HARQ feedback disabled processes or only applied to semi-statically HARQ feedback enabled processes.
      FFS #2: whether/how to support Option 3 overriding Option 1 configuration for corresponding transmission for multiple TBs scheduled by single DCI
      FFS #3: Option 3 DCI-based overridden mechanism is DCI signaling to reverse the HARQ feedback enable/disable for the corresponding transmission from per-HARQ process RRC configuration or DCI signaling to directly indicate the HARQ feedback enable/disable for the corresponding transmission regardless of per-HARQ process RRC configuration.
RAN1 strives to have a common design (in terms of DCI design, PDCCH monitoring, etc.) for “Option 3” and “Option 3+Option 1”.

For eMTC NTN, to configure/indicate enabling/disabling of HARQ feedback for downlink transmission, take Option 1 for CE Mode A.
Agreement
For DCI-based overridden/direct indication, down select one of the following based on the criteria DCI overhead, PDCCH monitoring behavior, impact on scheduling flexibility, UE implementation complexity, etc
   Option 1: Indication by adding one field in DCI
   Option 2: Indication by reusing/reinterpreting existing field in DCI
RAN1 #112-bis-e
Agreement
For Option 3 DCI indication:
   Option A: when both per-HARQ process bitmap and DCI solution enabling/disabling signaling are configured
   DCI-based overridden mechanism is DCI signaling to reverse the HARQ feedback enable/disable for the corresponding transmission from per-HARQ process RRC configuration
   For single TB scheduled by DCI, the DCI based overridden indication is applied to one of the following options (to be down-selected):
   Option A-1: only applied to semi-statically HARQ disabled processes
   Option A-4: applied to both semi-statically HARQ disabled and enabled processes
   FFS for multiple TBs scheduled by single DCI
   Option B: DCI-based HARQ enabling/disabling direct indication in case DCI solution enabling/disabling signaling is configured and per-HARQ process bitmap signaling is not configured (i.e. no bitmap is configured)
   DCI-based mechanism is DCI signaling to directly indicate the HARQ feedback enable/disable for the corresponding transmission
   For single TB scheduled by DCI, DCI-based direct indication is applied to the scheduled TB
   FFS for multiple TBs scheduled by single DCI
[Proposal 1-8c]
For single TB scheduled by DCI
   For DCI-based direct indication, down select one of the following based on the criteria DCI overhead, PDCCH monitoring behavior, impact on scheduling flexibility, UE implementation complexity, etc
   Option 1: Indication by adding one field in DCI (e.g., 1-bit)
   Note: Other fields in DCI are the same as legacy.
   Option 2: Indication by reusing/reinterpreting existing field in DCI
   Option 2A: HARQ-ACK related field
   For eMTC CE mode B, one state of “HARQ-ACK resource offset” field in DCI format 6-1B is used for indication of HARQ feedback disabled, other states are used for indication of HARQ feedback enabled and corresponding HARQ-ACK resource.
   FFS: detailed state
   For NBIoT, one state of “HARQ-ACK resource” field in DCI format N1 is used for indication of HARQ feedback disabled, other states are used for indication of HARQ feedback enabled and corresponding HARQ-ACK resource.
   FFS: detailed state
   Option 2B: MCS or repetition number field
   Reduce 1 bit of legacy MCS or repetition number field and add 1 bit new field in DCI format 6-1B and N1 to indicate the HARQ feedback enabled/disabled
   FFS: detailed for interpreting of the reduced MCS or repetition number field
   Option 2C: HARQ-ACK related field v2
   For eMTC CE mode B, reduce 1 bit of legacy “HARQ-ACK resource offset” field and add 1 bit new field in DCI format 6-1B to indicate the HARQ feedback enabled/disabled
   FFS: detailed for interpreting of the reduced “HARQ-ACK resource offset” field.
   For NBIoT, reduce 1 bit of legacy “HARQ-ACK resource” field and add 1 bit new field in DCI format N1 to indicate the HARQ feedback enabled/disabled
   FFS: detailed for interpreting of the reduced “HARQ-ACK resource” field
   Option 2D: Other indication by reusing/reinterpreting existing field.

### SUMMARY

One embodiment under the present disclosure comprises a method performed by a UE for being configured with a GNSS measurement gap. The method comprises receiving, from a network node, one or more values capable of defining a GNSS measurement gap instance, wherein the one or more values define the GNSS measurement gap instance regardless of whether a HARQ feedback is enabled or disabled for one or more downlink HARQ processes.

Another embodiment of a method under the present disclosure is a method performed by a network node for configuring a UE with a GNSS measurement gap. The method comprises transmitting, to the UE, one or more values capable of defining a GNSS measurement gap instance, wherein the one or more values define the GNSS measurement gap instance regardless of whether a HARQ feedback is enabled or disabled for one or more downlink HARQ processes.

Another possible embodiment under the present disclosure is a UE for being configured with a GNSS measurement gap. The UE comprises processing circuitry configured to perform the steps of; receiving, from a network node, one or more values capable of defining a GNSS measurement gap instance, wherein the one or more values define the GNSS measurement gap instance regardless of whether a HARQ feedback is enabled or disabled for one or more downlink HARQ processes. The UE further comprises power supply circuitry configured to supply power to the processing circuitry.

Another possible embodiment under the present disclosure is a network node for configuring a UE with a GNSS measurement gap. The network node comprises processing circuitry configured to perform the steps of; transmitting, to the UE, one or more values capable of defining a GNSS measurement gap instance, wherein the one or more values define the GNSS measurement gap instance regardless of whether a HARQ feedback is enabled or disabled for one or more downlink HARQ processes. The network node also comprises power supply circuitry configured to supply power to the processing circuitry.

Another embodiment under the present disclosure comprises a UE for being configured with a GNSS measurement gap. The UE comprises an antenna configured to send and receive wireless signals; and radio front-end circuitry connected to the antenna and to processing circuitry and configured to condition signals communicated between the antenna and the processing circuitry. The processing circuitry is configured to perform the steps of receiving, from a network node, one or more values capable of defining a GNSS measurement gap instance, wherein the one or more values define the GNSS measurement gap instance regardless of whether a HARQ feedback is enabled or disabled for one or more downlink HARQ processes. The UE also comprises an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows an example architecture of a satellite network with bent pipe transponders;

FIG. 2 shows the propagation delay distances between satellite and UE for different orbital heights and elevation angles;

FIG. 3 illustrates parameters for orbital elements;

FIG. 4 illustrates use of 2 HARQ processes for a Cat-NB2 UE;

FIG. 5 shows Table 16.4.2-1 from 3GPP TS 36.213 V17.5.0;

FIG. 6 shows Table 16.4.2-2 from 3GPP TS 36.213 V17.5.0;

FIG. 7 shows a table of combined usage of up to 14 HARQ processes and HARQ-ACK bundling for a Cat-M1 HD-FDD UE;

FIG. 8 shows Table 7.3.1-2 from 3GPP TS 36.213 V17.5.0;

FIG. 9 shows Table 5.3.3.1.12-1 from 3GPP TS 36.212 V17.1.0;

FIG. 10 shows Table 5.3.3.1.12-2 from 3GPP TS 36.212 V17.5.0;

FIG. 11 shows Table 5.3.3.1.12-3 from 3GPP TS 36.212 V17.5.0;

FIG. 12 illustrates possible subframe data for a single DL (downlink) HARQ process with HARQ feedback disabled;

FIG. 13 illustrates possible subframe data for LTE-MTC examples using 8 HARQ processes with HARQ-ACK bundling, and where all the HARQ processes have their HARQ feedback enabled;

FIG. 14 illustrates possible subframe data for a single HARQ process with HARQ feedback disabled;

FIG. 15 illustrates subframe data for an example assuming HARQ process #0 carries the “GNSS gap trigger indication”;

FIG. 16 illustrates subframe data for an example assuming HARQ process #1 carries the “GNSS gap trigger indication”;

FIG. 17 illustrates possible subframe data for an example of NB-IoT over NTN using two HARQ processes and where all the HARQ processes have their HARQ feedback enabled;

FIG. 18 illustrates a flow-chart of a method embodiment under the present disclosure;

FIG. 19 illustrates a flow-chart of a method embodiment under the present disclosure;

FIG. 20 shows a schematic of a communication system embodiment under the present disclosure;

FIG. 21 shows a schematic of a user equipment embodiment under the present disclosure;

FIG. 22 shows a schematic of a network node embodiment under the present disclosure; and

FIG. 23 shows a schematic of a virtualization environment embodiment under the present disclosure.

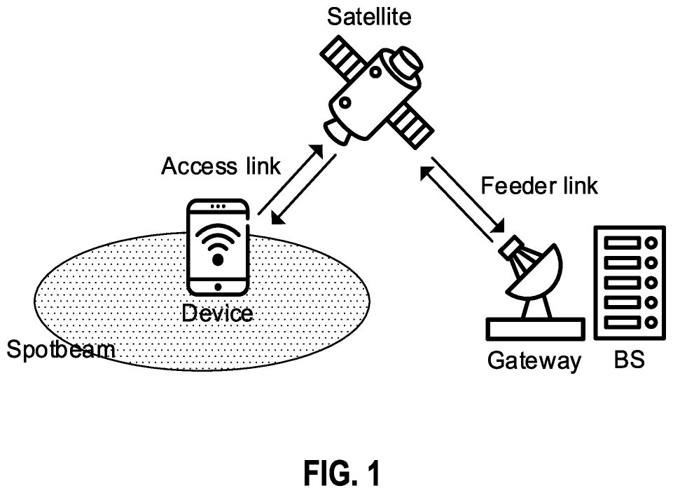

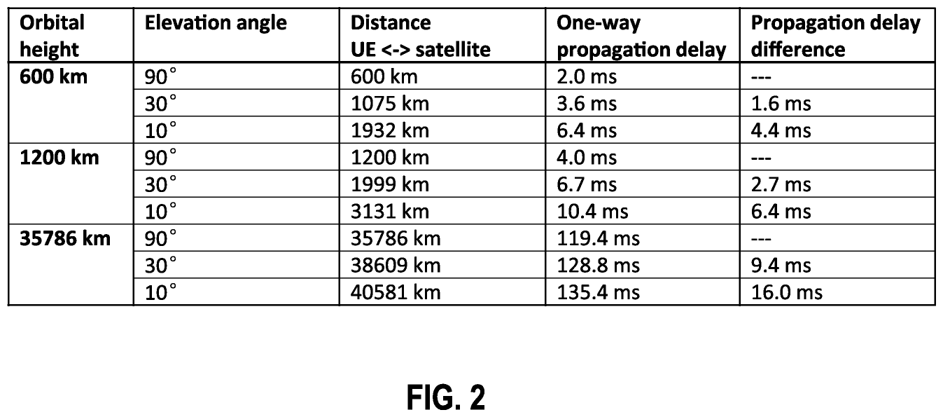

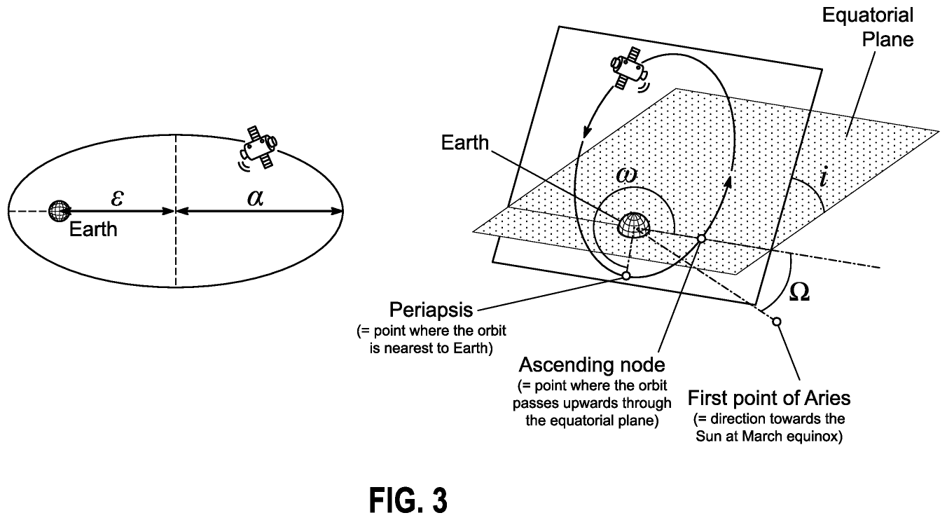

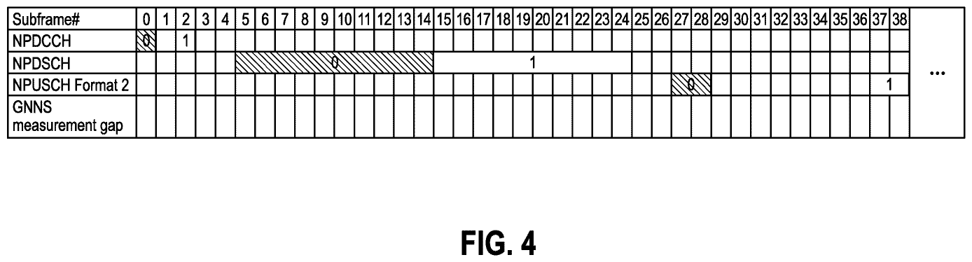

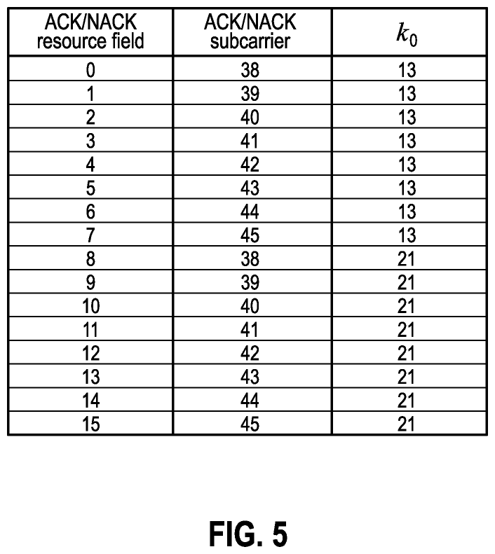

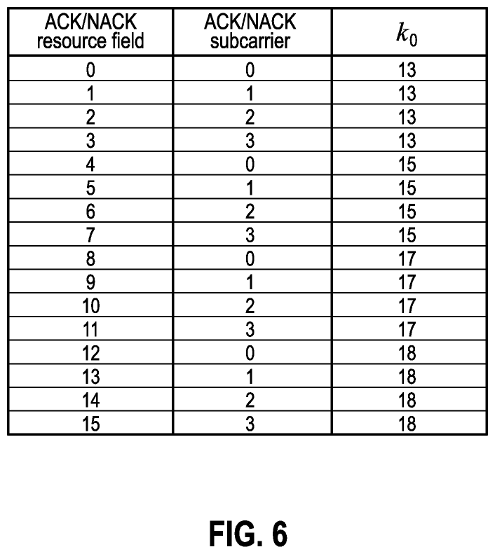

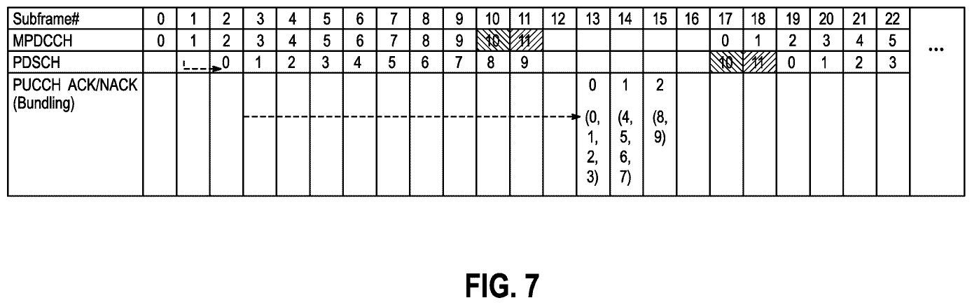

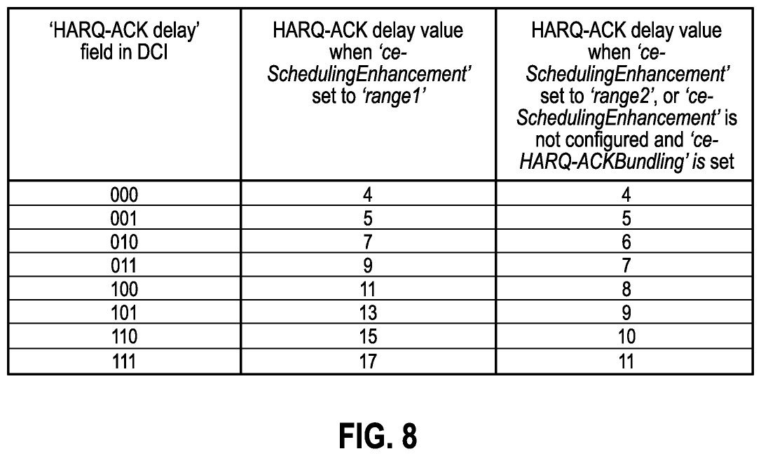

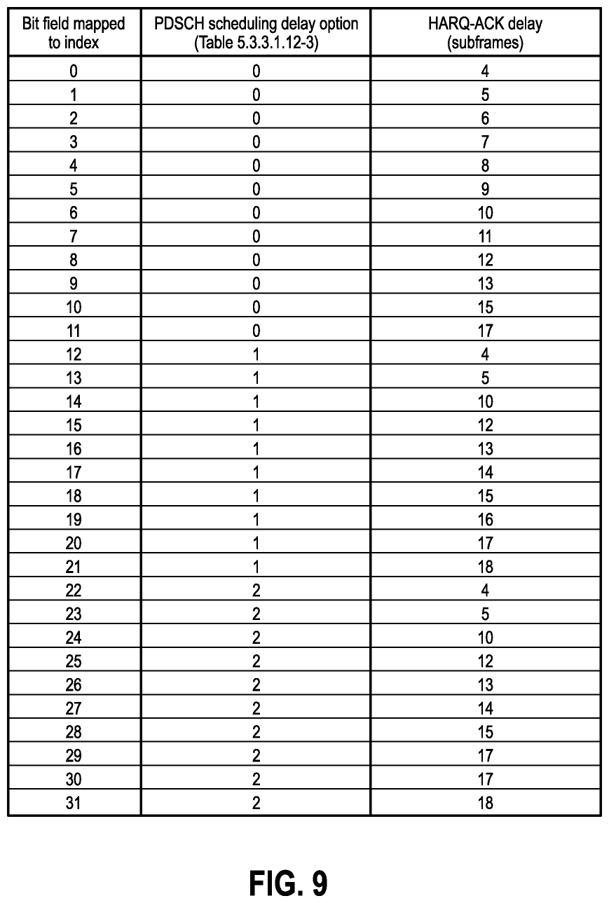

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges. A Rel-18 IoT NTN UE is expected to perform a GNSS reacquisition during RRC_CONNECTED mode when triggered by the network and/or upon GNSS validity duration expiry. To enable a GNSS measurement, the eNB can configure the UE with a GNSS measurement gap of a certain duration during which the UE can attempt a GNSS position fix. The eNB command to trigger an aperiodic GNSS measurement will be sent to the UE using a MAC control element (CE) in subframe/slot n for a GNSS measurement gap starting in subframe/slot n+X. Therefore, methods to determine the starting instance n+X (e.g., how to determine the value of X) are needed. In Rel-18 IoT NTN, it is possible to enable or disable the HARQ feedback for one or more DL HARQ processes. Therefore, any method to determine X should account for HARQ feedback.

Certain aspects of the disclosure and their embodiments may provide solutions to these or other challenges. Certain embodiments of the disclosure enable a network to configure a UE with a GNSS measurement gap while accommodating different scenarios with respect to HARQ feedback for downlink HARQ processes.

Embodiments include methods to determine the starting instance of GNSS measurement gap in the following scenarios relative to the MAC CE containing the GNSS measurement trigger:
HARQ feedback is disabled for all the DL HARQ processes;
HARQ feedback is enabled for all the DL HARQ processes; or
HARQ feedback is enabled for at least one DL HARQ process and disabled for at least one DL HARQ processes.

Certain embodiments may provide one or more of the following technical advantages. Certain embodiments facilitate configuring a GNSS measurement gap without disrupting the downlink HARQ feedback (if configured) for one or more DL HARQ processes. In certain embodiments the DL HARQ processes for which HARQ feedback is preserved or enabled may not necessarily be the HARQ process that was used to configure the GNSS measurement. Embodiments also address various scenarios with respect to HARQ feedback and cover both eMTC NTN and NB-IoT NTN.

Some of the embodiments contemplated herein will now be described more fully with reference to the accompanying drawings. Embodiments are provided by way of example to convey the scope of the subject matter to those skilled in the art.

Some embodiments are presented for the GNSS gap starting instance in LTE-MTC based NTN.

In one embodiment, a common value range for X is defined for the GNSS gap starting instance regardless of whether the HARQ feedback is enabled or disabled for one or more DL HARQ processes. For example, the value range may include all the possible values for the case where HARQ feedback is disabled as well as when it is enabled.

Alternatively, separate value ranges for X for the GNSS gap starting instance are defined depending on whether HARQ feedback is disabled or enabled.

In an additional embodiment, a common value range for X is defined for the GNSS gap starting instance regardless of the physical layer numerology (e.g., subcarrier spacing), and/or the number of configured HARQ processes, and/or whether HARQ bundling is used for transmitting HARQ feedback. For example, the common value range may include values relevant for all of the aforementioned scenarios.

Alternatively, separate value ranges for X are defined depending on the physical layer numerology (e.g., subcarrier spacing), and/or the number of configured HARQ processes, and/or whether HARQ bundling is used for transmitting HARQ feedback.

When HARQ feedback is disabled for a HARQ process, there is no PUCCH (Physical Uplink Control Channel) to be transmitted for that HARQ process (as there is no HARQ feedback to be transmitted for that HARQ process). So, after a 3 ms delay, a subsequent MPDCCH (MTE Physical Downlink Control Channel) can be received for the same or another HARQ process which is up to the eNB (evolved NodeB) scheduler to decide. When a GNSS measurement gap is triggered by the eNB, the UE needs to decode the PDSCH (Physical Downlink Shared Channel) carrying the GNSS trigger command for getting the GNSS gap triggering instruction. Thus, it is necessary to account for the minimum processing time that the UE requires to decode PDSCH.

In one embodiment, when HARQ feedback is disabled for eMTC (Enhanced MTC), the starting instance of the GNSS gap is set to n+X where X is the minimum processing time needed by the UE to decode the PDSCH carrying the GNSS gap triggering instruction. For example, the starting instance of the GNSS gap could be set to n+X, where X=3 subframes (i.e., X spans a duration of 3 ms) so as to account for the minimum processing time that the UE requires to decode the PDSCH carrying the GNSS gap triggering instruction.

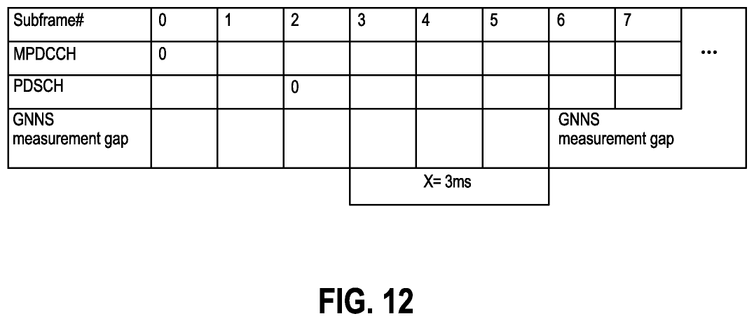

For a single DL (downlink) HARQ process with HARQ feedback disabled, the table in FIG. 12 illustrates the scenario. It should be noted that MPDCCH #0 carries the control information that schedules PDSCH #0″ which in turn carries the user data for HARQ process #0.

In one embodiment, when there are more than one HARQ processes in use and a GNSS measurement gap is triggered, the eNB in some cases will postpone (or schedule) the transmission of the one or more PDSCHs associated to one or more MPDCCHs that were received prior to the start of the GNSS measurement gap to after the end of the GNSS measurement gap. That is, the PDSCHs for such postponed HARQ processes will be transmitted after the end of the GNSS measurement gap (otherwise they would have overlapped with the GNSS measurement gap, and the UE may not be able to receive them). Alternatively, the PDSCH for such a HARQ process which overlaps with the GNSS measurement gap is not transmitted even after the end of the GNSS gap, i.e., the UE will not attempt to detect and decode the “postponed” PDSCH whose corresponding MPDCCH was received prior to the start of the GNSS gap as it is not transmitted.

In a sub-embodiment, the eNB may indicate the time/frequency resources of the HARQ processes to be rescheduled/postponed (due to GNSS gap) using legacy signalling methods. In another embodiment, it can be specified in the standard that if a scheduled DL HARQ process reception instance (e.g., receiving subframe/slot) partially or fully overlaps (i.e., falls within) with a GNSS measurement gap, its transmission is postponed by a certain time offset Y until after the gap, where Y can be indicated by the eNB or defined as a fixed offset in the specification. In another embodiment, the previously indicated time-domain resources allocation (e.g., subframe/slot/symbol/repetitions) for the postponed HARQ processes is applied in the frames following the end of the GNSS measurement gap.

When HARQ feedback is enabled for a HARQ process, there is a PUCCH to be transmitted for that HARQ process (i.e., there is HARQ feedback ACK/NACK to be transmitted for that HARQ process using the Physical Uplink Control Channel, PUCCH).

In one embodiment, the “GNSS measurement gap” can start from the subframe after the subframe/slot used to transmit the last PUCCH.

In one embodiment, it is important to consider that in LTE-MTC it is possible to use up to 8-HARQ processes, up to 10-HARQ processes or up to 14-HARQ processes, this means that there might be more than one PUCCH to be transmitted, even if HARQ-ACK bundling were used (as to have up 4 ACKs/NACKs per PUCCH) there could be up to three PUCCHs to be transmitted. Thus, it is better to generalize the description of “X” in terms of the HARQ-ACK delay and the number of PUCCHs to be transmitted.

In another embodiment, if HARQ feedback is enabled for all HARQ processes, X can be determined using the following rule to account for the presence of one or more than one HARQ processes and that the “GNSS gap triggering indication” can be carried in any of those HARQ processes (the solution also avoids disrupting the transmission of HARQ feedback):
X=HARQ-ACK delay+(#PUCCHs not overlapping with the HARQ-ACK delay)+“half-duplex guard subframe”; or
X=HARQ-ACK delay+(#PUCCHs not overlapping with the HARQ-ACK delay)+1.

It should be noted that if the PDSCH and/or PUCCH are transmitted using only the BL/CE subframes, and/or the HARQ-ACK delay accounts for only the BL/CE subframes, then the rule needs to be adjusted accordingly by adding the number of non-BL/CE subframes (that occur in between the subframe containing the last HARQ-ACK on PUCCH and its nearest corresponding PDSCH subframe which that HARQ-ACK corresponds to) when calculating the value of X.

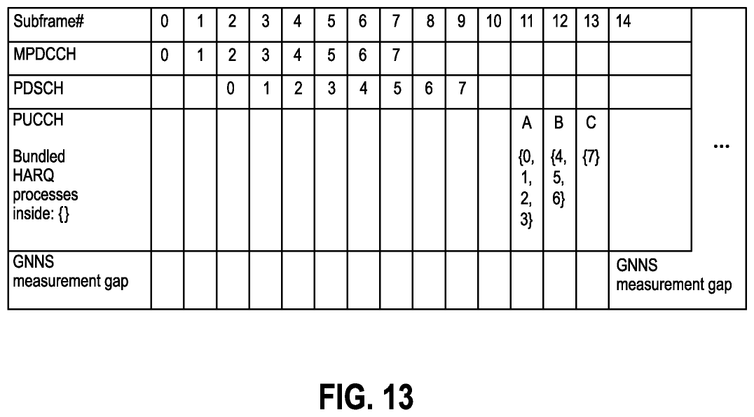

Below are several LTE-MTC examples using 8 HARQ processes with HARQ-ACK bundling, and where all the HARQ processes have their HARQ feedback enabled. Both examples can be based on the table of subframes shown in FIG. 13.

In a first LTE-MTC Example 1: An “aperiodic GNSS measurement gap” is “triggered by eNB with MAC CE”, assuming it was indicated using HARQ process #0 in which case “n is the end of MAC CE receiving subframe/slot” where “n” is subframe #2. Using the proposed rule:
HARQ-ACK delay=9 (note that HARQ process #0 is ACKed/NACKed using the first PUCCH tagged as “A”, therefore a HARQ-ACK delay of 9 subframes is required).
#PUCCHs not overlapping the HARQ-ACK delay=2 (Using HARQ-ACK bundling, three PUCCHs are needed to handle this 8 HARQ processes scenario. The HARQ-ACK delay overlaps A, but not B and C, thus the number of PUCCHs not overlapping the HARQ-ACK delay is 2).
half-duplex guard subframe=1.

Thus, “the start time should be at n+X” which is at subframe #14 (i.e., “n” is at subframe #2, if after it we count 12 subframes, this will result in subframe #14 where the “GNSS measurement gap” starts).

In a second LTE-MTC Example 2: An “aperiodic GNSS measurement gap” is “triggered by eNB with MAC CE”, assuming it was indicated using HARQ process #7 in which case “n is the end of MAC CE receiving subframe/slot” where “n” is subframe #9. Using the proposed rule:
HARQ-ACK delay=4 (Please note that HARQ process #7 is ACKed/NACKed using the last PUCCH tagged as “C,” therefore a HARQ-ACK delay of 4 subframes is required).
#PUCCHs not overlapping the HARQ-ACK delay=0 (Using HARQ-ACK bundling, three PUCCHs are needed to handle this 8 HARQ processes scenario. The HARQ-ACK delay overlaps with A, B and C, thus the number of PUCCHs not overlapping the HARQ-ACK delay is 0).
half-duplex guard subframe=1.

Thus, “the start time should be at n+X” which is at subframe #14 (i.e., “n” is at subframe #9, if after it we count 5 subframes, this will yield subframe #14 where the “GNSS measurement gap” starts).

Some embodiments are presented for GNSS gap starting instance in NB-IoT based NTN. In NB-IoT, up to two DL HARQ processes can be in use.

In one embodiment, a common value range for X is defined for the GNSS gap starting instance regardless of whether the HARQ feedback is enabled or disabled for one or more DL HARQ processes. For example, the value range may include all the possible values for the case where HARQ feedback is disabled as well as when it is enabled.

Alternatively, separate value ranges for X are defined for the GNSS gap starting instance depending on whether HARQ feedback is disabled or enabled.

In an additional embodiment, a common value range for X is defined for the GNSS gap starting instance regardless of the physical layer numerology (e.g., subcarrier spacing), and/or the number of configured HARQ processes, and/or whether HARQ bundling is used for transmitting HARQ feedback. For example, the common value range may include values relevant for all of the aforementioned scenarios.

Alternatively, separate value ranges for X are defined depending on the physical layer numerology (e.g., subcarrier spacing), and/or the number of configured HARQ processes, and/or whether HARQ bundling is used for transmitting HARQ feedback.

When HARQ feedback is disabled for a HARQ process, there is no NPUSCH (Narrowband PUSCH) Format 2 to be transmitted for that HARQ process (as there is no HARQ feedback to be transmitted for that HARQ process). So, if there is only one HARQ process in use, then after 12 ms a subsequent NPDCCH (Narrowband PDCCH) can be received for the same HARQ process.

When a GNSS measurement gap is configured, the UE needs to decode NPDSCH (Narrowband PDSCH) carrying the GNSS trigger command for getting the GNSS gap triggering instruction. Thus, it is necessary to account for the minimum processing time that the UE requires to decode NPDSCH.

In one embodiment, when HARQ feedback is disabled for NB-IoT, the starting instance of the GNSS gap is set to n+X where X is the minimum processing time needed by the UE to decode the (N) PDSCH carrying the GNSS gap triggering instruction. For example, the starting instance of the GNSS gap could be set to n+X where X=12 ms so as to account for the minimum processing time that the UE requires to decode NPDSCH carrying the GNSS gap triggering instruction.

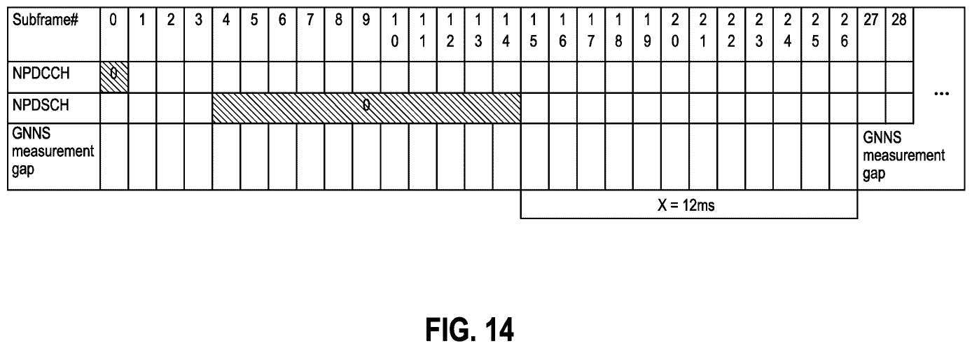

For a single HARQ process with HARQ feedback disabled, the subframe table shown in FIG. 14 illustrates a possible scenario.

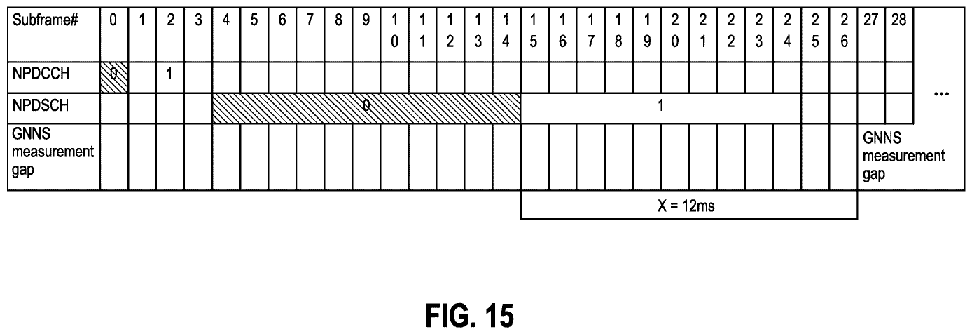

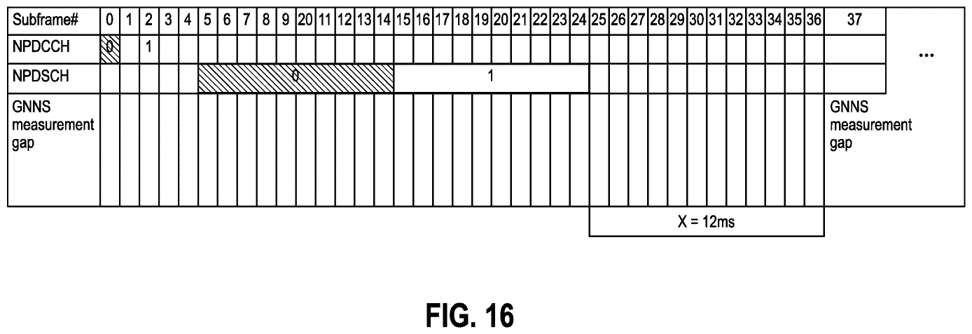

If two HARQ processes are used, both will have time to receive their NPDSCHs before the start of the GNSS measurement gap. However, the GNSS measurement gap will postpone the subsequent transmission of NPDCCH(s) until after the end of the GNSS gap, which is illustrated in the examples shown in FIGS. 15 and 16. The example in FIG. 15 is shown assuming HARQ process #0 carries the “GNSS gap trigger indication.” The example in FIG. 16 is shown assuming HARQ process #1 carries the “GNSS gap trigger indication.”

When HARQ feedback is enabled for a HARQ process, there is a NPUSCH Format 2 to be transmitted for that HARQ process (i.e., there is HARQ feedback ACK/NACK to be transmitted for that HARQ process using the Narrowband Physical Uplink Shared Channel format 2), which can use a 15 KHz subcarrier spacing (i.e., Resource Unit length of 2 ms for NPUSCH Format 2) or a 3.75 KHz subcarrier spacing (i.e., Resource Unit length of 8 ms for NPUSCH Format 2).

In one embodiment, the “GNSS measurement gap” can start from the subframe after the last subframe/slot used to transmit NPUSCH Format 2.

In one embodiment, it is important to consider that in NB-IoT it is possible to use up to two HARQ processes, this means that there might be more than one NPUSCH Format 2 to be transmitted. Thus, it is better to generalize the description of “X” in terms of the variable that determines the gap between NPDSCH and NPUSCH Format 2 (i.e., “k₀”) in Table 16.4.2-1 of TS 36.213 V17.5.0 for 3.75 KHz subcarrier spacing or in Table 16.4.2-2 of TS 36.213 V17.5.0 for 15 KHz subcarrier spacing, number of HARQ processes to be transmitted, and the RU length of NPUSCH Format 2.

In another embodiment, if HARQ feedback is enabled for all the DL HARQ processes, X can be determined using the following rule to account for the presence of one or more HARQ processes with the understanding that the “GNSS gap trigger command” can be carried in any of those HARQ processes in use (note that the solution also avoids disrupting due to GNSS gap the transmission of HARQ feedback for these HARQ processes):

X=y subframes, wherein:

$$y = {k}_{0} + {RU}_{{lengt}_{{NPU}_{{Format}_{2}}}} ,$$

if there is only one HARQ process in use and “GNSS measurement gap\”” is triggered using that HARQ process;

$$y = {k}_{{0}_{\_ HARQ Process \# 0}} + {k}_{{0}_{\_ HARQ Process \# 1}} - ( {k}_{{0}_{\_ HARQ Process \# 1}} - {NSF}_{HARQ Process \#1} ) + {RU}_{{length}_{{NPUSC}_{Forma 2}}} ,$$

if there are two HARQ processes in use and “GNSS measurement gap\”” is triggered using HARQ process “#” 0;

$$y = {k}_{{0}_{\_ HARQ Process \# 1}} + {RU}_{{length}_{{NPUSC}_{{Format}_{2}}}} ,$$

if there are two HARQ processes in use and “GNSS measurement gap\”” is triggered using HARQ process “#” 1;
where “k₀” is obtained from Table 16.4.2-2 of TS 36.213 V17.5.0 when NPUSCH Format 2 uses a 15 KHz subcarrier spacing (Table 16.4.2-1 of TS 36.213 V 17.5.0 is used when NPUSCH Format 2 uses a 3.75 KHz subcarrier spacing), and “NSF” is the number of NPDSCH subframes.

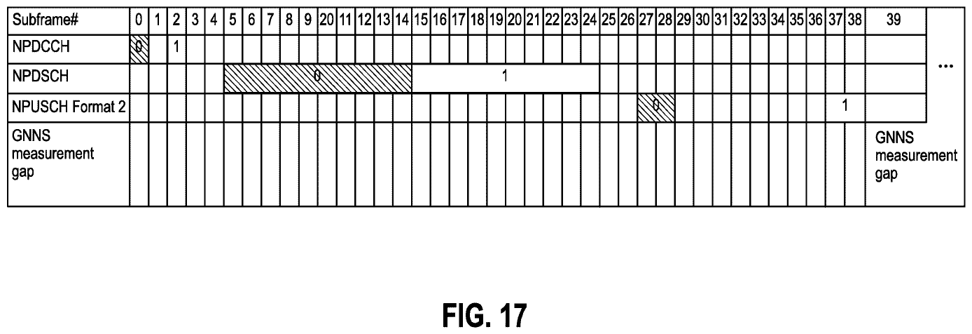

Below are several examples for NB-IoT over NTN using two HARQ processes and where all the HARQ processes have their HARQ feedback enabled. These two examples are based around the chart of subframes shown in FIG. 17.

In a first example, in a two HARQ processes scenario, an “aperiodic GNSS measurement gap” is “triggered by eNB with MAC CE” assuming it was indicated using HARQ process #0 in which case “n is the end of MAC CE receiving subframe/slot” where “n” is subframe #14.

Using the proposed rule:

$${k}_{{0}_{\_ HARQ Process \# 0}} + {k}_{{0}_{\_ HARQ Process \# 1}} - ( {k}_{{0}_{\_ HARQ Process \# 1}} - {NSF}_{HARQ Process \#1} ) + {RU}_{{length}_{{NPUS}_{Format \_ 2}}}$$

results in the following:
K_{0_}_{_{HARQ Process #0}}=“k₀”=13 from 16.4.2-2 of TS 36.213 as applied in the diagram above;
K_{0_}_{_{HARQ Process #1}}=“k₀”=13 from 16.4.2-2 of TS 36.213 as applied in the diagram above;
NSF_{HARQ Process #1}=10 as in the diagram above (i.e., The TBS associated to HARQ process #1 is mapped on 10 NPDSCH subframes);

$${RU}_{{leng}_{{NPUSCH}_{Format \_ 2}}} = 2 as in the diagram above ( i . e . , for SCS = 15 kHz ) ;$$

$$y = {k}_{{0}_{\_ HARQ Process \# 0}} + {k}_{{0}_{\_ HARQ Process \# 1}} - ( {k}_{{0}_{\_ HARQ Process \# 1}} - {NSF}_{HARQ Process \#1} ) + {RU}_{{length}_{{NPUS}_{Format \_ 2}}} = 13 + 10 + 2 = 25.$$

Thus, X=25 such that the “GNSS measurement gap” starts at subframe #39.

In a second example, in a two HARQ processes scenario, an “aperiodic GNSS measurement gap” is “triggered by eNB with MAC CE”, assuming it was indicated using HARQ process #1 in which case “n is the end of MAC CE receiving subframe/slot” where “n” is subframe #24.

Using the proposed rule:

$$y = {k}_{{0}_{\_ HARQ Process \# 1}} + {RU}_{{leng}_{{NPUS}_{Format \_ 2}}}$$

results in:
K_{0_}_{_{HARQ Process #1}}=“k₀”=13 from 16.4.2-2 of TS 36.213 as applied in the diagram above;
RU_{len NPUSCH}_{_{Format,2}}=2 as in the diagram above (i.e., for SCS=15 kHz);

$$y = {k}_{{0}_{\_ HARQ Process \# 1}} + {RU}_{{lengt}_{{NPUS}_{Format \_ 2}}} = 13 + 2 = 15.$$

Thus, X=15 such that the GNSS measurement gap starts at subframe #39.

When there is more than one HARQ process present, it is possible that one or more HARQ process(es) can have HARQ feedback enabled, whereas one or more other HARQ process(es) can have HARQ feedback disabled, which leads to a hybrid or mixed HARQ feedback Enabled/Disabled scenario.

In one embodiment, the proposed solutions for LTE-MTC and NB-IoT that apply when HARQ feedback is enabled can be re-used in a hybrid scenario since as long as there is one HARQ process with HARQ feedback enabled, we need to wait for the PUCCH/NPUSCH_Format_2 transmission to avoid disruption in transmitting HARQ feedback before starting the GNSS measurement gap.

In another embodiment, in a hybrid or mixed HARQ feedback Enabled/Disabled scenario re-using the proposed solutions that apply when HARQ feedback is enabled would imply that the HARQ processes with HARQ feedback disabled will artificially keep using “k0” and “HARQ-ACK delay”. That is, when HARQ feedback is disabled, “k0” for NB-IoT and “HARQ-ACK delay” for LTE-MTC are not used since there is no “NPUSCH_Format_2” nor “PUCCH” to be transmitted, however in order to re-use the equations that determine “X” for NB-IoT and LTE-MTC, the HARQ processes with HARQ feedback disabled would have to select a “k0” and “HARQ-ACK delay” as if an ACK/NACK were to be send even though “NPUSCH_Format_2” nor “PUCCH” are actually not transmitted, which can be seen in this case as a virtual reference.

Alternatively, to avoid the artificial determination of “k0” and “HARQ-ACK delay” and using a “virtual” NPUSCH_Format_2 and PUCCH as a reference (as it is the case in the previous embodiment), it could be concluded/assumed that in order to re-use the equations that determine “X” for NB-IoT and LTE-MTC, as long as one among all the HARQ processes has HARQ feedback enabled, then all HARQ processes report HARQ feedback where the HARQ process with HARQ feedback disabled reports e.g., an “ACK” (or NACK) by default.

In one embodiment, the value range of X is defined to include values such that it includes all possible scenarios with respect to HARQ feedback for the HARQ processes.

In one embodiment, the GNSS gap starting instance “n+X” is determined by the eNB using one or more of the aforementioned methods and the parameter “X” is explicitly indicated by the eNB to the UE using the MAC CE for the GNSS trigger. Alternatively, it is indicated separately using a different MAC CE or DCI or RRC configuration.

In one embodiment, the GNSS gap starting instance “n+X” is determined by the UE using one or more of the aforementioned methods and the parameter “X” is implicitly determined by the UE based on the information about HARQ configuration, e.g., the number of HARQ processes and whether/how HARQ-ACK feedback is to be transmitted for those HARQ processes.

In another embodiment, the UE determines the GNSS gap starting instance “n+X” by using a combination of the information transmitted by the eNB in the GNSS trigger command as well as other information about HARQ configuration known to the UE.

In one embodiment, if the starting instance of the GNSS gap (e.g., information about X) is explicitly indicated by the eNB to the UE, then it overrides a previously indicated value of X.

In one embodiment, if the starting instance of the GNSS gap (e.g., information about X) is explicitly indicated by the eNB to the UE, then it overrides the value of X determined implicitly by the UE.

In one embodiment, the solutions are applicable when the Multi-TB grant feature is used. That is, when Multi-TB grant is used, one (M/N) PDCCH is used to schedule data (i.e., PDSCH) for several HARQ processes. Certain embodiments described herein are with respect to the PDSCH associated with the “GNSS triggering indication” thus the solutions for LTE-MTC and NB-IoT should be compatible with the Multi-TB grant.

In one embodiment, for LTE-MTC the HARQ-ACK delay can be expressed in terms of subframes as illustrated through this document, and the solution are expected to be compatible if the HARQ-ACK delay were expressed in terms of different subframe types (e.g., BL/CE DL subframes, BL/CE UL subframes, subframes) as to handle the presence of invalid subframes.

In one embodiment, the eNB can configure the start of GNSS measurement gap without waiting for the transmission of HARQ feedback for one or more HARQ processes whose HARQ feedback was enabled, and they were received before the start of the GNSS measurement gap. In a sub-embodiment, if the HARQ feedback cannot be transmitted because it overlaps with the GNSS gap, it is postponed or rescheduled by eNB until after the GNSS gap. Alternatively, it is not transmitted at all if it overlaps with a GNSS gap, i.e., both the eNB and UE have a common understanding that such HARQ feedback (that overlaps with a GNSS gap) is not to be transmitted.

In one embodiment, the eNB can leverage the one or more embodiments described herein to schedule uplink/downlink resources or set configuration for one or more (or any combination thereof) of the following cases:

GNSS measurement trigger command, e.g., select in which HARQ process or subframe the GNSS measurement command will be transmitted e.g., whether to choose the first HARQ process or the last HARQ process to transmit the GNSS trigger command.

Whether to enable or disable the HARQ feedback for the HARQ process carrying the GNSS measurement trigger command

HARQ-ACK resources, whether HARQ feedback will be bundled or not, etc.

Whether to enable or disable HARQ feedback for one or more HARQ processes which are scheduled to be transmitted before the start of a GNSS gap e.g., if the eNB determines that the UE's uplink synchronization can still be maintained even if a large value for X is chosen, then the eNB may enable the HARQ feedback for the HARQ processes transmitted before the GNSS gap. The idea is to allow the UE the possibility to transmit HARQ feedback on the uplink by delaying the start of the GNSS gap. Alternatively, eNB may disable HARQ feedback for one or more HARQ processes to avoid overlap of HARQ feedback transmission with a GNSS gap if the eNB intends to configure a small value for X to avoid loss in uplink synchronization to GNSS validity expiry.

In another embodiment, the eNB can leverage the one or more embodiments described herein to determine the GNSS measurement gap starting instance (i.e., n+X or X) for a UE. For example, for the various scenarios described previously, an eNB may leverage the rules specified in these sections to determine the minimum possible value for X that is needed to support the transmission of HARQ feedback for one or more HARQ processes before the start of the GNSS gap. It may explicitly indicate this value to the UE or indicate a different value.

In another embodiment, the rules to determine the starting time of the GNSS measurement command disclosed herein are specified in the standard specification. Alternatively, the rules to determine the starting time of the GNSS measurement command disclosed herein are used to derive the numerical value range for “X”, and the value range is specified in the standard specification.

In another embodiment, the UE determines the starting time (i.e., X) of the gap based on the rules disclosed herein unless the eNB explicitly configures a value for X to the UE. In a sub-embodiment, a special value of X or a 1-bit flag is defined such that if the eNB indicates it to the UE, the UE determines the starting time (i.e., X) of the gap based on the rules disclosed herein.

In another embodiment, if the eNB chooses not to indicate a value for X to the UE for a GNSS measurement command, the UE uses the previously used value for X if indicated by the eNB for a previous GNSS measurement trigger command. Alternatively, if the eNB chooses not to indicate a value for X to the UE, the UE determines the starting time (i.e., X) of the GNSS gap based on the rules disclosed herein.

In one embodiment, HARQ feedback is always enabled for the HARQ process carrying the GNSS measurement trigger command unless indicated otherwise by the eNB. In another embodiment, if HARQ feedback is enabled for the HARQ process carrying the GNSS measurement trigger command, HARQ bundling is not used unless indicated otherwise by the eNB. In another embodiment, if HARQ feedback is enabled for the HARQ process carrying the GNSS measurement trigger command, HARQ bundling is used unless indicated otherwise by the eNB. In another embodiment, the eNB can include information about enabling/disabling of HARQ feedback and/or type of HARQ feedback for the HARQ process carrying the GNSS measurement trigger command as part of the GNSS measurement trigger command. Alternatively, this information for the HARQ process carrying the GNSS trigger command is indicated using a new message via DCI, MAC or RRC signalling. As another alternative, this information for the HARQ process carrying the GNSS trigger command is indicated using the legacy (e.g., Rel-17 or Rel-18 3GPP specification) mechanism for disabling/enabling HARQ feedback, configuring type of HARQ feedback, etc.

As an extension of the above embodiment, the eNB can include information about whether HARQ feedback is enabled or disabled for one or more HARQ processes (including the HARQ process used to send the GNSS command) as part of the GNSS measurement trigger command. It can also include information if HARQ feedback is to be postponed until after the end of the gap and the resources for HARQ feedback.

All of the disclosed embodiments described herein can also be applied to the case where GNSS measurement gap is triggered by using RRC signalling.

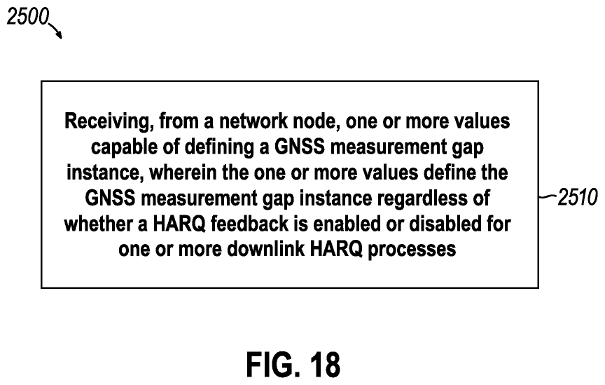

FIG. 18 shows a possible method embodiment under the present disclosure. Method 2500 is a method performed by a UE for being configured, or receiving a configuration, with a GNSS measurement gap. Step 2510 is receiving, from a network node, one or more values capable of defining a GNSS measurement gap instance, wherein the one or more values define the GNSS measurement gap instance regardless of whether a HARQ feedback is enabled or disabled for one or more downlink HARQ processes. Method 2500 can comprise a variety of additional, alternative, and/or optional steps, and/or other variations.

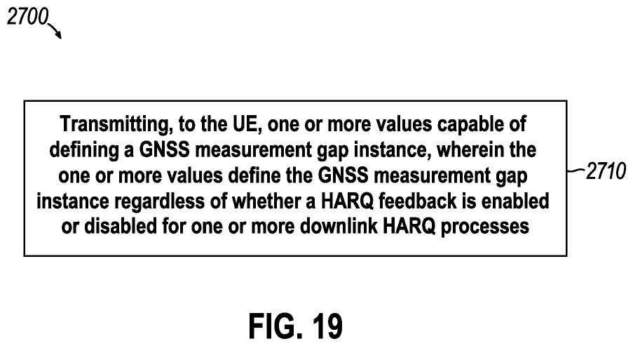

FIG. 19 shows a possible method embodiment under the present disclosure. Method 2700 is a method performed by a network node for configuring a UE with a GNSS measurement gap. Step 2710 is transmitting, to the UE, one or more values capable of defining a GNSS measurement gap instance, wherein the one or more values define the GNSS measurement gap instance regardless of whether a HARQ feedback is enabled or disabled for one or more downlink HARQ processes. Method 2700 can comprise a variety of additional, alternative, and/or optional steps, and/or other variations.

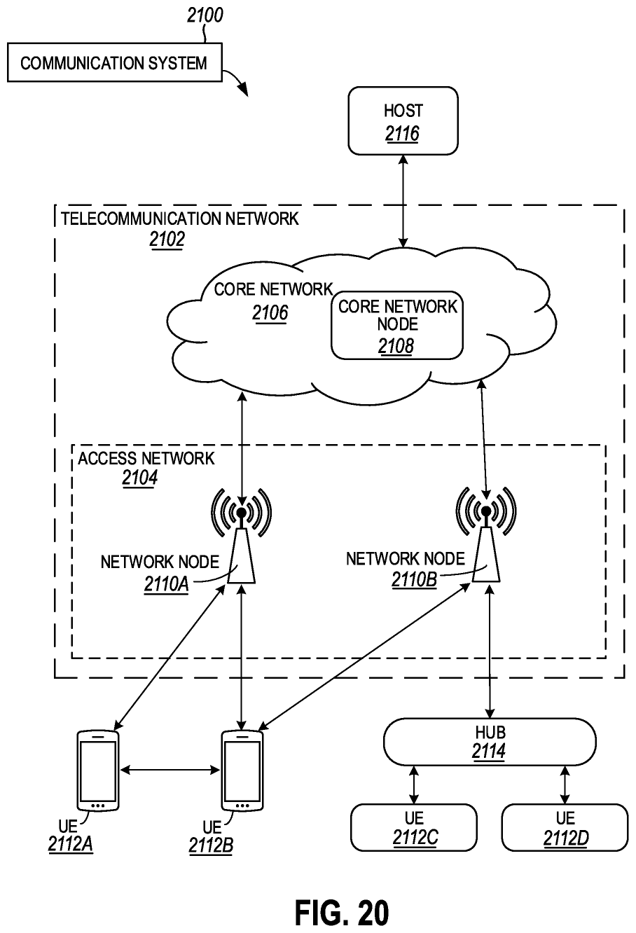

FIG. 20 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

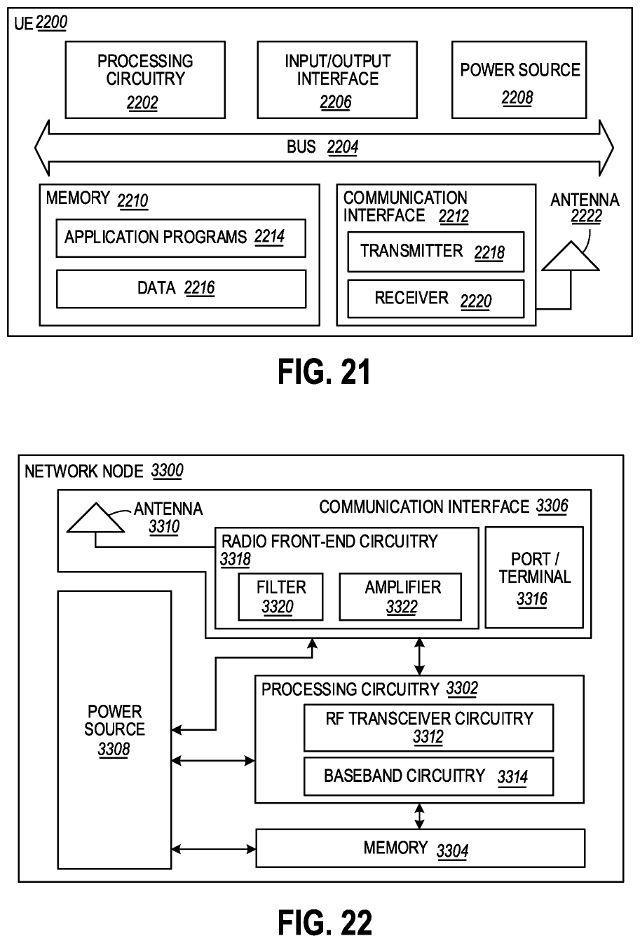

FIG. 21 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

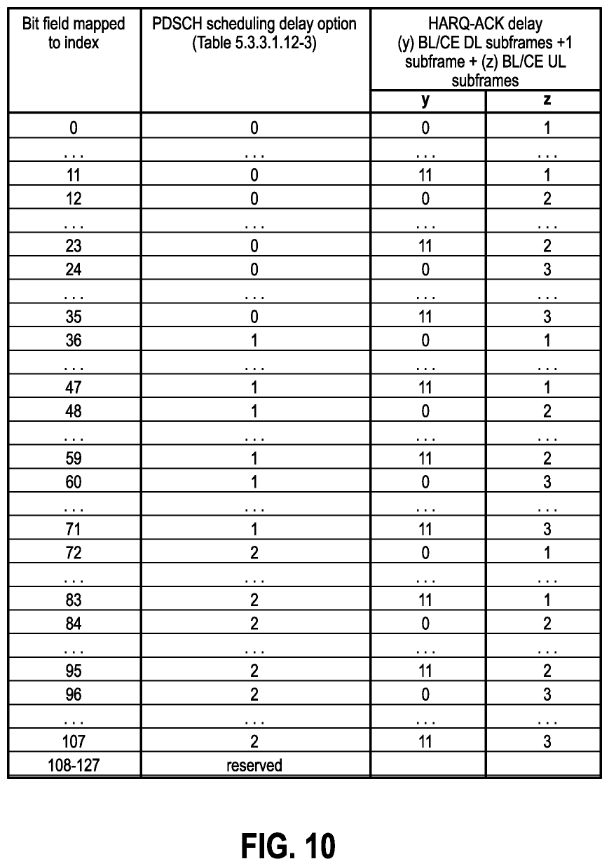

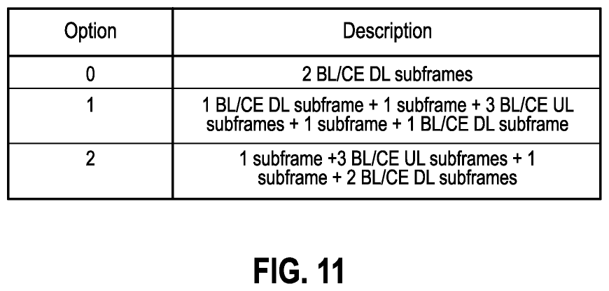

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 22 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

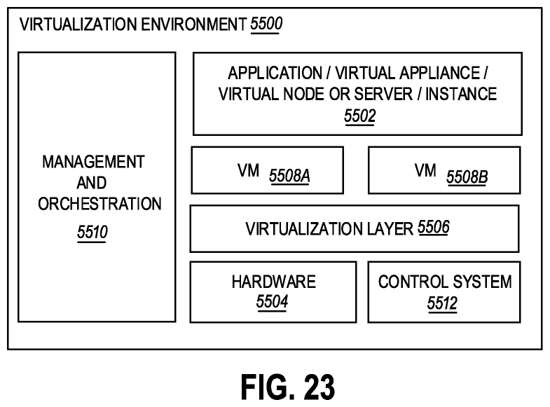

FIG. 23 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The embodiments outlined herein are described mainly in terms of LTE based (including IoT) NTNs, but they are equally applicable in an NTN based on NR (including IoT) technology. The term “network” is used to refer to a network node, which typically will be an eNB (e.g., in a LTE based NTN such as IoT NTN), but which may also be a gNB (e.g., in a NR based NTN), or a base station or an access point in another type of network, or any other network node with the ability to directly or indirectly communicate with a UE. GNSS can form part of various embodiments. The most well-known is the American Global Positioning System (GPS), but there are also other also other similar systems which could provide the functionality utilized in the proposed embodiments, e.g., the Russian Global Navigation Satellite System (GLONASS), the Chinese BeiDou Navigation Satellite System, and the European Galileo. The terms “connected mode”, “RRC_CONNECTED state” or “RRC_CONNECTED mode” are used interchangeably. When a signaling message or parameter, or a UE behavior, is specified in a standard, this is in this document referred to as “standardized”, “specified” or “specified in a standard”. That is, these expressions/terms are equivalent. The term/expression “GNSS position fix time duration” refers to the time the UE needs to perform a GNSS position fix (i.e., a successful GNSS position measurement), which may vary e.g., depending on the UE's GNSS state (often referred to as “hot”, “warm” and “cold” state, or “hot start”, “warm start” and “cold start”). The term “n+X” is used to refer to the starting instance of the GNSS measurement gap, where n refers to the last subframe/slot (or other time unit) in which the command for triggering a GNSS measurement gap was received (e.g., the last subframe in which the MAC CE triggering a GNSS measurement gap was received), and “X” denotes the additional time offset (X may have the same time unit as “n” e.g., “X” can be the number of subframes, or X may represent a time duration e.g. in ms, etc.) before the GNSS measurement gap can start. Other time units are not precluded. Through this description, the terms “LTE-MTC” and “eMTC” are used interchangeably. Any references to TS 36.213 refer to the 3GPP specification TS 36.213 version 17.5.0.

### EXAMPLES

The following are examples according to the above disclosure:
Example 1. A method performed by a user equipment for being configured with a Global Navigation Satellite System, GNSS, measurement gap, the method comprising: receiving, from a network node, one or more values capable of defining a GNSS measurement gap instance.
Example 2. The method of example 1, wherein the one or more values define the GNSS measurement gap instance regardless of whether a Hybrid Automatic Repeat request, HARQ, feedback is enabled or disabled for one or more downlink HARQ processes.
Example 3. The method of example 1, wherein different of the one or more values defined the GNSS measurement gap instance depending on whether Hybrid Automatic Repeat request, HARQ, feedback is enabled or disabled.
Example 4. The method of example 1, wherein the one or more values define the GNSS measurement gap instance regardless of at least one of: physical layer numerology (e.g., subcarrier spacing); a number of configured Hybrid Automatic Repeat request, HARQ, processes; and whether HARQ bundling is used for transmitting HARQ feedback.
Example 5. The method of example 1, wherein different of the one or more values defined the GNSS measurement gap instance depending on at least one of: physical layer numerology (e.g., subcarrier spacing); a number of configured Hybrid Automatic Repeat request, HARQ, processes; and whether HARQ bundling is used for transmitting HARQ feedback.
Example 6. A method performed by a network node for configuring a user equipment, UE, with a Global Navigation Satellite System, GNSS, measurement gap, the method comprising: transmitting, to the UE, one or more values capable of defining a GNSS measurement gap instance.
Example 7. The method of example 6, wherein the one or more values define the GNSS measurement gap instance regardless of whether a Hybrid Automatic Repeat request, HARQ, feedback is enabled or disabled for one or more downlink HARQ processes.
Example 8. The method of example 6, wherein different of the one or more values defined the GNSS measurement gap instance depending on whether Hybrid Automatic Repeat request, HARQ, feedback is enabled or disabled.
Example 9. The method of example 6, wherein the one or more values define the GNSS measurement gap instance regardless of at least one of: physical layer numerology (e.g., subcarrier spacing); a number of configured Hybrid Automatic Repeat request, HARQ, processes; and whether HARQ bundling is used for transmitting HARQ feedback.
Example 10. The method of example 6, wherein different of the one or more values defined the GNSS measurement gap instance depending on at least one of: physical layer numerology (e.g., subcarrier spacing); a number of configured Hybrid Automatic Repeat request, HARQ, processes; and whether HARQ bundling is used for transmitting HARQ feedback.
Example 11. The method of example 8, wherein LTE-MTC over NTN HARQ feedback is disabled.
Example 12. The method of example 11, wherein if HARQ feedback is disabled for Machine Type Communication, MTC, the starting instance of the GNSS gap is set to n+X, where X is the minimum processing time that the UE requires to decode the Physical Downlink Shared Channel, PDSCH, carrying the GNSS gap triggering instruction.
Example 13. The method of example 11, wherein when there are more than one HARQ processes in use and a GNSS measurement gap is triggered, then the network node postpones or schedules transmission of the Physical Downlink Shared Channel, PDSCHs, associated to Machine Type communication Physical Downlink Control Channels, MPDCCHs, that were received prior to the start of the GNSS measurement gap, i.e., received before the lapse of the duration “PDSCH scheduling delay plus X ms” (e.g., X-3 ms) after the end of the received subframe containing a GNSS measurement trigger from the network node.
Example 14. The method of example 11, wherein when there are more than one HARQ processes in use and a GNSS measurement gap is triggered, the PDSCH for such a HARQ process is not transmitted after the end of the GNSS gap, i.e., the UE will not attempt to detect and decode PDSCH whose corresponding MPDCCH was received prior to the start of the GNSS gap.
Example 15. The method of example 13 or 14, wherein the network node may indicate the time/frequency resources of the HARQ processes to be rescheduled/postponed (due to GNSS gap) using legacy signalling methods.
Example 15. The method of example 13 or 14, wherein it can be specified in the standard that if a scheduled DL HARQ process reception instance (e.g., receiving subframe/slot) partially or fully overlaps (i.e., falls within) with a GNSS measurement gap, its transmission is postponed by a certain time offset Y until after the gap, where Y can be indicated by the network node or defined as a fixed offset in the specification.
Example 16. The method of example 13 or 14, wherein the previously indicated time-domain resources allocation (e.g., subframe/slot/symbol/repetitions) for the postponed HARQ processes is applied in the frames following the end of the GNSS measurement gap.
Example 17. The method of example 8, wherein LTE-MTC over NTN HARQ feedback is enabled.
Example 18. The method of example 17, wherein the GNSS measurement gap starts from the subframe after the subframe/slot used to transmit the last PUCCH.
Example 19. The method of example 17, wherein if HARQ feedback is enabled for all HARQ processes, then the GNSS measurement gap is determined by:

X=HARQ-ACK delay+(#PUCCHs not overlapping with the HARQ-ACK delay)+“half-duplex guard subframe”.
Example 20. The method of example 17, wherein if HARQ feedback is enabled for all HARQ processes, then the GNSS measurement gap is determined by:

X=HARQ-ACK delay+(#PUCCHs not overlapping with the HARQ-ACK delay)+1.
Example 21. The method of example 8, wherein NB-IoT over NTN HARQ feedback is disabled.
Example 22. The method of example 21, wherein the starting instance of the GNSS gap is set to n+X where X is the minimum processing time that the UE requires to decode NPDSCH carrying the GNSS gap triggering instruction.
Example 23. The method of example 8, wherein NB-IoT over NTN HARQ feedback is enabled.
Example 24. The method of example 23, wherein the GNSS measurement gap can start from the subframe after the last subframe/slot used to transmit NPUSCH Format 2.
Example 25. The method of example 23, wherein there are more than one NPUSCH Format 2 to be transmitted.
Example 26. The method of example 23, wherein if HARQ feedback is enabled for all the DL HARQ processes, GNSS measurement gap (X) can be determined using the following rule to account for the presence of one or more HARQ processes with the understanding that the “GNSS gap trigger command” can be carried in any of those HARQ processes in use (note that the solution also avoids disrupting due to GNSS gap the transmission of HARQ feedback for these HARQ processes):

X=y subframes, wherein:

$$y = {k}_{0} + {RU}_{{len}_{{NPUSCH}_{{Form}_{2}}}} ,$$

if there is only one HARQ process in use and “GNSS measurement gap” is triggered using that HARQ process

$$y = {k}_{{0}_{\_ HARQ Process 0}} + {k}_{{0}_{\_ HARQ Process 1}} - ( {k}_{{0}_{\_ HARQ Process 1}} - {NSF}_{HARQ Process 1} ) + {RU}_{{leng}_{{NPUS}_{{Format}_{2}}}} ,$$

if there are two HARQ processes in use and “GNSS measurement gap” is triggered using HARQ process #0

$${k}_{{0}_{\_ HARQ Process 1}} + {RU}_{{lengt}_{{NPU}_{{Form}_{2}}}} ,$$

if there are two HARQ processes in use and “GNSS measurement gap” is triggered using HARQ process #1
Example 27. The method of example 8, wherein HARQ feedback is enabled for at least one DL HARQ process and disabled for at least one DL HARQ processes.
Example 28. The method of example 27, wherein the proposed solutions for LTE-MTC and NB-IoT that apply when HARQ feedback is enabled can be re-used in a hybrid scenario since as long as there is one HARQ process with HARQ feedback enabled, the system waits for the PUCCH/NPUSCH_Format_2 transmission to avoid disruption in transmitting HARQ feedback before starting the GNSS measurement gap.
Example 29. The method of example 27, wherein re-using the proposed solutions that apply when HARQ feedback is enabled implies that the HARQ processes with HARQ feedback disabled will virtually keep using “k0” and “HARQ-ACK delay”.
Example 30. The method of example 27, wherein, to avoid the “virtualization” of “k0” in the case of NB-IoT and “HARQ-ACK delay” in the case of LTE-MTC, it could be concluded/assumed that as long as one among all the HARQ processes has HARQ feedback enabled, then all HARQ processes report HARQ feedback where e.g., the HARQ process with HARQ feedback disabled reports an “ACK” (or NACK) by default.
Example 31. The method of any of examples 6 to 10, wherein the one or more values of GNSS measurement gap is defined to include values such that it includes all possible scenarios w.r.t to HARQ feedback for the HARQ processes.
Example 32. The method of any of examples 6 to 10, wherein the GNSS gap starting instance “n+X” is determined by the network node using one or more of the aforementioned methods and the parameter “X” is explicitly indicated by the eNB to the UE using the MAC CE for the GNSS trigger.
Example 33. The method of any of examples 6 to 10, wherein the GNSS gap starting instance “n+X” is determined by the UE using one or more of the aforementioned methods and the parameter “X” is implicitly determined by the UE based on the information about HARQ configuration, e.g., the number of HARQ processes and whether/how HARQ-ACK feedback is to be transmitted for those HARQ processes.
Example 34. The method of any of examples 6 to 10, wherein the UE determines the GNSS gap starting instance “n+X” by using a combination of the information transmitted by the eNB in the GNSS trigger command as well as other information about HARQ configuration known to the UE.
Example 35. The method of any of examples 6 to 10, wherein if the starting instance of the GNSS gap (e.g., information about X) is explicitly indicated by the eNB to the UE, then it overrides previously indicated value of X.
Example 36. The method of any of examples 6 to 10, wherein if the starting instance of the GNSS gap (e.g., information about X) is explicitly indicated by the eNB to the UE, then it overrides the value of X determined implicitly by the UE.
Example 37. The method of any of examples 6 to 10, wherein the solutions are applicable when the Multi-TB grant feature is used. That is, when Multi-TB grant is used, one (M/N) PDCCH is used to schedule data (i.e., PDSCH) for several HARQ processes.
Example 38. The method of any of examples 6 to 10, wherein for LTE-MTC the HARQ-ACK delay can be expressed in terms of subframes, and the solution are expected to be compatible if the HARQ-ACK delay were expressed in terms of different subframe types (e.g., BL/CE DL subframes, BL/CE UL subframes, subframes) as to handle the presence of invalid subframes.
Example 39. The method of any of examples 6 to 10, wherein the eNB can configure the start of GNSS measurement gap without waiting for the transmission of HARQ feedback for one or more HARQ processes whose HARQ feedback was enabled, and they were received before the start of the GNSS measurement gap.
Example 40. The method of example 39, wherein if the HARQ feedback cannot be transmitted because it overlaps with the GNSS gap, it is postponed or rescheduled by eNB until after the GNSS gap.
Example 41. The method of example 39, wherein the HARQ feedback is not transmitted at all if it overlaps with a GNSS gap, i.e., both the eNB and UE have a common understanding that such HARQ feedback (that overlaps with a GNSS gap) is not to be transmitted.
Example 42. The method of any of examples 6 to 41, wherein the eNB can schedule uplink/downlink resources or set configuration for one or more (or any combination thereof) of the following cases: GNSS measurement trigger command, e.g., select in which HARQ process or subframe the GNSS measurement command will be transmitted e.g., whether to choose the first HARQ process or the last HARQ process to transmit the GNSS trigger command: whether to enable or disable the HARQ feedback for the HARQ process carrying the GNSS measurement trigger command; HARQ-ACK resources, whether HARQ feedback will be bundled or not, etc; whether to enable or disable HARQ feedback for one or more HARQ processes which are scheduled to be transmitted before the start of a GNSS gap e.g., if the eNB determines that the UE's uplink synchronization can still be maintained even if a large value for X is chosen, then the eNB may enable the HARQ feedback for the HARQ processes transmitted before the GNSS gap. The idea is to allow the UE the possibility to transmit HARQ feedback on the uplink by delaying the start of the GNSS gap. Alternatively, eNB may disable HARQ feedback for one or more HARQ processes to avoid overlap of HARQ feedback transmission with a GNSS gap if the eNB intends to configure a small value for X to avoid loss in uplink synchronization to GNSS validity expiry.
Example 43. The method of any of examples 6 to 41, wherein the eNB can determine the GNSS measurement gap starting instance (i.e., n+X or X) for a UE.
Example 44. The method of any of examples 6 to 41, wherein the rules to determine the starting time of the GNSS measurement command disclosed herein are specified in the standard specification.
Example 45. The method of any of examples 6 to 41, wherein the rules to determine the starting time of the GNSS measurement command disclosed herein are used to derive the numerical value range for “X”, and the value range is specified in the standard specification.
Example 46. The method of any of examples 6 to 41, wherein the UE determines the starting time (i.e., X) of the gap based on the rules disclosed herein unless the eNB explicitly configures a value for X to the UE.
Example 47. The method of example 46, wherein, a special value of X or a 1-bit flag is defined such that if the eNB indicates it to the UE, the UE determines the starting time (i.e., X) of the gap based on the rules disclosed herein.
Example 48. The method of any of examples 6 to 41, wherein if the eNB chooses not to indicate a value for X to the UE for a GNSS measurement command, the UE uses the previously used value for X if indicated by the eNB for a previous GNSS measurement trigger command.
Example 49. The method of any of examples 6 to 41, wherein if the eNB chooses not to indicate a value for X to the UE, the UE determines the starting time (i.e., X) of the GNSS gap based on the rules disclosed herein.
Example 50. The method of any of examples 6 to 41, wherein HARQ feedback is always enabled for the HARQ process carrying the GNSS measurement trigger command unless indicated otherwise by the eNB.
Example 51. The method of any of examples 6 to 41, wherein if HARQ feedback is enabled for the HARQ process carrying the GNSS measurement trigger command, HARQ bundling is not used unless indicated otherwise by the eNB.
Example 52. The method of any of examples 6 to 41, wherein if HARQ feedback is enabled for the HARQ process carrying the GNSS measurement trigger command, HARQ bundling is used unless indicated otherwise by the eNB.
Example 53. The method of any of examples 6 to 41, wherein the eNB can include information about enabling/disabling of HARQ feedback and/or type of HARQ feedback for the HARQ process carrying the GNSS measurement trigger command as part of the GNSS measurement trigger command.
Example 54. The method of any of examples 6 to 41, wherein information for the HARQ process carrying the GNSS trigger command is indicated using a new message via DCI, MAC or RRC signalling.
Example 55. The method of any of examples 6 to 41, wherein information for the HARQ process carrying the GNSS trigger command is indicated using the legacy (e.g., Rel-17 or Rel-18 3GPP specification) mechanism for disabling/enabling HARQ feedback, configuring type of HARQ feedback, etc.
Example 56. The method of example 55, wherein the eNB can include information about whether HARQ feedback is enabled or disabled for one or more HARQ processes (including the HARQ process used to send the GNSS command) as part of the GNSS measurement trigger command.
Example 57. The method of example 56, wherein the eNB also includes information if HARQ feedback is to be postponed until after the end of the gap and the resources for HARQ feedback
Example 58. The method of any of examples 6 to 57, wherein GNSS measurement gap is triggered by using RRC signalling.
Example 59. The method of any of examples 6 to 58, wherein the network node comprises at least one of: gNB; eNB; base station; satellite.
Example 60. A user equipment for being configured with a Global Navigation Satellite System, GNSS, measurement gap, comprising: processing circuitry configured to perform any of the steps of any of examples 1 to 5; and power supply circuitry configured to supply power to the processing circuitry.
Example 61. A network node for configuring a user equipment, UE, with a Global Navigation Satellite System, GNSS, measurement gap, the network node comprising: processing circuitry configured to perform any of the steps of any of examples 6 to 59; power supply circuitry configured to supply power to the processing circuitry.
Example 62. A user equipment (UE) for being configured with a Global Navigation Satellite System, GNSS, measurement gap, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of examples 1 to 5; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

1. A method performed by a user equipment, UE, for being configured with a Global Navigation Satellite System, GNSS, measurement gap, the method comprising:
receiving, from a network node, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes.

2. The method of claim 1, wherein the starting instance of the GNSS gap is dependent on whether HARQ feedback is enabled or disabled.

3. The method of claim 1, wherein when HARQ feedback is disabled the starting instance of the GNSS gap is set to n+X where X is a minimum processing time needed by the UE to decode the PDSCH carrying the GNSS gap triggering instruction.

4. The method of claim 1, wherein the one or more values define the GNSS measurement gap instance regardless of at least one of: physical layer numerology (e.g., subcarrier spacing); a number of configured Hybrid Automatic Repeat request, HARQ, processes; and whether HARQ bundling is used for transmitting HARQ feedback.

5. A method performed by a network node for configuring a user equipment, UE, with a Global Navigation Satellite System, GNSS, measurement gap, the method comprising:
transmitting, to the UE, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes.

6. The method of claim 5, wherein the starting instance of the GNSS gap is dependent on whether HARQ feedback is enabled or disabled.

7. The method of claim 5, wherein when HARQ feedback is disabled the starting instance of the GNSS gap is set to n+X where X is a minimum processing time needed by the UE to decode the PDSCH carrying the GNSS gap triggering instruction.

8. The method of claim 5, wherein the one or more values define the GNSS measurement gap instance regardless of at least one of: physical layer numerology (e.g., subcarrier spacing); a number of configured Hybrid Automatic Repeat request, HARQ, processes; and whether HARQ bundling is used for transmitting HARQ feedback.

9. The method of claim 5, wherein when there are more than one HARQ processes in use and a GNSS measurement gap is triggered, then the network node postpones or schedules transmission of the Physical Downlink Shared Channel, PDSCHs, associated to Machine Type communication Physical Downlink Control Channels, MPDCCHs, that were received prior to the start of the GNSS measurement gap, i.e., received before the lapse of the duration “PDSCH scheduling delay plus X ms” after the end of the received subframe containing a GNSS measurement trigger from the network node.

10. The method of claim 5, wherein when the HARQ feedback is enabled the GNSS measurement gap starts from a subframe after the subframe/slot used to transmit the last PUCCH.

11. The method of claim 5, wherein the UE is an NB-IoT over NTN UE and HARQ feedback is disabled and the starting instance of the GNSS gap is set to n+X where X is the minimum processing time that the UE requires to decode NPDSCH carrying the GNSS gap triggering instruction.

12. The method of claim 5, wherein the UE is an NB-IoT over NTN UE and HARQ feedback is enabled, and wherein the GNSS measurement gap can start from the subframe after the last subframe/slot used to transmit NPUSCH Format 2.

13. The method of claim 5, wherein HARQ feedback is always enabled for the HARQ process carrying the GNSS measurement trigger command unless indicated otherwise by the base station.

14. The method of claim 5, wherein if HARQ feedback is enabled for the HARQ process carrying the GNSS measurement trigger command, HARQ bundling is not used unless indicated otherwise by the network node.

15. The method of claim 5, wherein if HARQ feedback is enabled for the HARQ process carrying the GNSS measurement trigger command, HARQ bundling is used unless indicated otherwise by the network node.

16. (canceled)

17. A user equipment, UE, for being configured with a Global Navigation Satellite System, GNSS, measurement gap, comprising:
processing circuitry configured to perform the steps of:
receiving, from a network node, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes; and power supply circuitry configured to supply power to the processing circuitry.

18. (canceled)

19. A network node for configuring a user equipment, UE, with a Global Navigation Satellite System, GNSS, measurement gap, the network node comprising:
processing circuitry configured to perform the steps of:
transmitting, to the UE, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes; and
power supply circuitry configured to supply power to the processing circuitry.

20-22. (canceled)

23. The method of claim 1, wherein when there are more than one HARQ processes in use and a GNSS measurement gap is triggered, then the network node schedules transmission of the Physical Downlink Shared Channel, PDSCHs, associated to Machine Type communication Physical Downlink Control Channels, MPDCCHs, that were received prior to the start of the GNSS measurement gap, i.e., received before the lapse of the duration “PDSCH scheduling delay plus X ms” after the end of the received subframe containing a GNSS measurement trigger from the network node.

24. A user equipment, UE, for being configured with a Global Navigation Satellite System, GNSS, measurement gap, comprising:
processing circuitry configured to perform the steps of:
receiving, from a network node, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes, and
the method of claim 23; and
power supply circuitry configured to supply power to the processing circuitry.

25. A network node for configuring a user equipment, UE, with a Global Navigation Satellite System, GNSS, measurement gap, the network node comprising:
processing circuitry configured to perform the steps of:
transmitting, to the UE, one or more values capable of defining a GNSS measurement gap instance, wherein the one or more values define the GNSS measurement gap instance regardless of whether a Hybrid Automatic Repeat request, HARQ, feedback is enabled or disabled for one or more downlink HARQ processes, and
the method of claim 9; and
power supply circuitry configured to supply power to the processing circuitry.
